(19) United States
(12) Patent Application Publication
(10) Pub. No.: US 2006/0168398 A1
(43) Pub. Date: Jul. 27, 2006

(54) Distributed processing RAID system

(76) Inventor: Paul Cadaret, Rancho Santa Margarita, CA (US)

Correspondence Address: CROCKETT & CROCKETT, 24012 CALLE DE LA PLATA, SUITE 400, LAGUNA HILLS, CA, 92653, US

(21) Appl. No.: 11/338,119

(22) Filed: Jan. 23, 2006

Related U.S. Application Data
(60) Provisional application No. 60/646,268, filed on Jan. 24, 2005.

(51) Int. Cl. G06F 12/16

(52) U.S. Cl. 711/114

(57) ABSTRACT

A distributed processing RAID data storage system utilizing optimized methods of data communication between elements. In a preferred embodiment, such a data storage system will utilize efficient component utilization strategies at every level. Additionally, component interconnect bandwidth will be effectively and efficiently used; systems power will be rationed; systems component utilization will be rationed; enhance data-integrity and data-availability techniques will be employed; physical component packaging will be organized to maximize volumetric efficiency; and control logic of the implemented that maximally exploits the massively parallel nature of the component architecture.

### FIELD OF THE INVENTIONS

The inventions described below relate to the field of large capacity digital data storage and more specifically to large capacity RAID data storage incorporating distributed processing techniques.

### BACKGROUND OF THE INVENTIONS

Modern society increasingly depends on the ability to effectively collect, store, and access ever-increasing volumes of data. The largest data storage systems available today generally rely upon sequential-access tape technologies. Such systems can provide data storage capacities in the petabyte (PB) and exabyte (EB) range with reasonably high data-integrity, low power requirements, and at a relatively low cost. However, the ability of such systems to provide low data-access times, provide high data-throughput rates, and service large numbers of simultaneous data requests is generally quite limited. The largest disk-based data storage systems commercially available today can generally provide many tens of terabytes (TB) of random access data storage capacity, relatively low data-access times, reasonably high data-throughput rates, good data-integrity, good data-availability, and service a large number of simultaneous user requests, however, they generally utilize fixed architectures that are not scalable to meet PB/EB-class needs, may have huge power requirements, and they are quite costly, therefore, they such architectures are not suitable for use in developing PB or EB class data storage system solutions.

Modern applications are becoming ever more common that require data storage systems with petabyte and exabyte data storage capacities, very low data access times for randomly placed data requests, high data throughput rates, high data-integrity, high data-availability, and do so at lower cost than existing systems available today. Currently available data storage system technologies are generally unable to meet such demands and this causes IT system engineers to make undesirable design compromises. The basic problem encountered by designers of data storage systems is generally that of insufficient architectural scalability, flexibility, and reconfigurability.

These more demanding requirements of modern applications for increased access to more data at faster rates with decreased latency and at lower cost are subsequently driving more demanding requirements for data storage systems. These requirements then call for new types of data storage system architectures and components that effectively address these demanding and evolving requirements in new and creative ways. What is needed is a technique for incorporating distributed processing power throughout a RAID type data storage system to achieve controllable power consumption, scalable data storage capacity up to and beyond exabyte levels as well as dynamic error recovery processes to overcome hardware failures.

### SUMMARY OF THE INVENTIONS

Tremendous scalability, flexibility, and dynamic reconfigurability is generally the key to meeting the challenges of designing more effective data storage system architectures that are capable of satisfying the demands of evolving modern applications as described earlier. Implementing various forms of limited scalability in the design of large data storage systems is relatively straightforward to accomplish and has been described by others (Zetera, and others). Additionally, certain aspects of effective component utilization have been superficially described and applied by others in specific limited contexts (Copan, and possibly others). However, the basic requirement for developing effective designs that exhibit the scalability and flexibility required to implement effective PB/EB-class data storage systems is a far more challenging matter.

As an example of the unprecedented generally scalability that is required to meet such requirements the table below shows a series of calculations for the number of disk drives, semiconductor data storage devices, or other types of random-access data storage module (DSM) units that would be required to construct data storage systems that are generally considered to be truly “massive” by today's standards.

Rough Disk-Drive/Data-Storage-Module (DSM) Requirements
(in drives)
RAID overhead not considered

| Storage | | | | | | | |
|---|---|---|---|---|---|---|---|
| capacity | DSM Data Storage Capacity (GB) | | | | | | |
| (PB) | 250 | 400 | 500 | 1,000 | 5,000 | 10,000 | 50,000 |
| 0.1 | 4.00E+02 | 2.50E+02 | 2.00E+02 | 1.00E+02 | 2.00E+01 | 1.00E+01 | 2.00E+00 |
| 0.5 | 2.00E+03 | 1.25E+03 | 1.00E+03 | 5.00E+02 | 1.00E+02 | 5.00E+01 | 1.00E+01 |
| 1 | 4.00E+03 | 2.50E+03 | 2.00E+03 | 1.00E+03 | 2.00E+02 | 1.00E+02 | 2.00E+01 |
| 5 | 2.00E+04 | 1.25E+04 | 1.00E+04 | 5.00E+03 | 1.00E+03 | 5.00E+02 | 1.00E+02 |
| 10 | 4.00E+04 | 2.50E+04 | 2.00E+04 | 1.00E+04 | 2.00E+03 | 1.00E+03 | 2.00E+02 |
| 50 | 2.00E+05 | 1.25E+05 | 1.00E+05 | 5.00E+04 | 1.00E+04 | 5.00E+03 | 1.00E+03 |
| 100 | 4.00E+05 | 2.50E+05 | 2.00E+05 | 1.00E+05 | 2.00E+04 | 1.00E+04 | 2.00E+03 |
| 500 | 2.00E+06 | 1.25E+06 | 1.00E+06 | 5.00E+05 | 1.00E+05 | 5.00E+04 | 1.00E+04 |
| 1,000 | 4.00E+06 | 2.50E+06 | 2.00E+06 | 1.00E+06 | 2.00E+05 | 1.00E+05 | 2.00E+04 |
| 5,000 | 2.00E+07 | 1.25E+07 | 1.00E+07 | 5.00E+06 | 1.00E+06 | 5.00E+05 | 1.00E+05 |
| 10,000 | 4.00E+07 | 2.50E+07 | 2.00E+07 | 1.00E+07 | 2.00E+06 | 1.00E+06 | 2.00E+05 |
| 50,000 | 2.00E+08 | 1.25E+08 | 1.00E+08 | 5.00E+07 | 1.00E+07 | 5.00E+06 | 1.00E+06 |

As can be seen in the table above over 2500 400-gigabyte (GB) DSM units are required to make available a mere 1-PB of data storage capacity and this number does not take into account typical RAID-system methods and overhead that is typically applied to provide generally expected levels of data-integrity and data-availability. The table further shows if at some point in the future a massive 50-EB data storage system were needed, then over 1-M DSM units would be required even when a utilizing future 50-TB DSM devices. Such numbers of components are quite counterintuitive as compared to the everyday experience of system design engineers today and at first glance the development of such systems appears to be impractical. However, this disclosure will show otherwise.

Common industry practice has generally been to construct large disk-based data storage systems by using a centralized architecture for RAID-system management. Such system architectures generally utilize centralized high-performance RAID-system Processing and Control (RPC) functions. Unfortunately, the scalability and flexibility of such architectures is generally quite limited as is evidenced by the data storage capacity and other attributes of high-performance data storage system architectures and product offerings commercially available today.

Some new and innovative thinking is being applied to the area of large data storage system design. Some new system design methods have described network-centric approaches to the development of data storage systems, however, as yet these approaches do not appear to provide the true scalability and flexibility required to construct effective PB/EB-class data storage system solutions. Specifically, network-centric approaches that utilize broadcast or multicast methods for high-rate data communication are generally not scalable to meet PB/EB-class needs as will be subsequently shown.

The basic physics of the problem presents a daunting challenge the development of effective system solutions. The equation below describes the ability to access large volumes of data based on a defined data throughput rate.

$$\begin{matrix}Total\_System \_Access \_Time = ( \frac{Storage\_Capacity}{System\_Data \_Access \_Rate} ) \\ = ( \frac{1 PB}{( \frac{100 MB}{sec} )} ) \\ = ( \frac{1 \text{,} 000 \text{,} 000 \text{,} 000 \text{,} 000 \text{,} 000 bytes}{( \frac{100 \text{,} 000 \text{,} 000 bytes}{1 sec} )} ) \\ = ( \frac{1 \text{,} 000 \text{,} 000 \text{,} 000 \text{,} 000 \text{,} 000}{100 \text{,} 000 \text{,} 000} ) ( \frac{bytes * sec}{bytes} ) \\ = 10 \text{,} 000 \text{,} 000 sec \\ = 2 \text{,} 777.8 hours \\ = 115.7 days \\ = 3.85 months\end{matrix}$$

To put various commonly available network data rates in perspective the following table defines a number of currently available and future network data rates.

| Link Speed | Example |
|---|---|
| 100 MB/sec | A single 1 Gb/sec network link |
| 500 MB/sec | Multiple (×5) 1 Gb/sec network links |
| 1,000 MB/sec | A single 10 Gb/sec network link |
| 5,000 MB/sec | Multiple (×5) 10 Gb/sec network links |
| 10,000 MB/sec | Multiple (×10) 10 Gb/sec network links |
| 50,000 MB/sec | Multiple (×50) 10 Gb/sec network links |

The table below now applies these data rates to data storage systems of various data storage capacities and shows that PB/EB-class data storage capacities simply overwhelm current and near future data throughput rates as may be seen with modern and near future communication network architectures.

Storage Capacity vs. Total Data Access Time
Data Storage Module (Disk Drive) Size 400 GB
RAID overhead not considered

| | | System Data Throughput Rate (MB/s) | | | | | |
|---|---|---|---|---|---|---|---|
| Storage | | 100 | 500 | 1,000 | 5,000 | 10,000 | 50,000 |
| capacity | | Total System Array: Read/Write Time | | | | | |
| (PB) | # of drives | (days) | | | | | |
| 0.1 | 2.50E+02 | 11.6 | 2.3 | 1.2 | 0.23 | 0.12 | 0.02 |
| 0.5 | 1.25E+03 | 57.9 | 11.6 | 5.8 | 1.16 | 0.58 | 0.12 |
| 1 | 2.50E+03 | 115.7 | 23.1 | 11.6 | 2.31 | 1.16 | 0.23 |
| 5 | 1.25E+04 | 578.7 | 115.7 | 57.9 | 11.57 | 5.79 | 1.16 |
| 10 | 2.50E+04 | 1157.4 | 231.5 | 115.7 | 23.1 | 11.6 | 2.3 |
| 50 | 1.25E+05 | 5787.0 | 1157.4 | 578.7 | 115.7 | 57.9 | 11.6 |
| 100 | 2.50E+05 | 11574.1 | 2314.8 | 1157.4 | 231.5 | 115.7 | 23.1 |
| 500 | 1.25E+06 | 57870.4 | 11574.1 | 5787.0 | 1157.4 | 578.7 | 115.7 |
| 1,000 | 2.50E+06 | 115740.7 | 23148.1 | 11574.1 | 2314.8 | 1157.4 | 231.5 |
| 5,000 | 1.25E+07 | 578703.7 | 115740.7 | 57870.4 | 11574.1 | 5787.0 | 1157.4 |
| 10,000 | 2.50E+07 | 1157407.4 | 231481.5 | 115740.7 | 23148.1 | 11574.1 | 2314.8 |
| 50,000 | 1.25E+08 | 5787037.0 | 1157407.4 | 578703.7 | 115740.7 | 57870.4 | 11574.1 |

The inherent physics of the problem as shown in the table above highlights the fact that PB-class and above data storage systems will generally enforce some level of infrequent data access characteristics on such systems. Overcoming such characteristics will typically involve introducing significant parallelism into the system data access methods used. Additionally, effective designs for large PB-class and above data storage systems will likely be characterized by the ability to easily segment such systems into smaller data storage “zones” of varying capabilities. Therefore, effective system architectures will be characterized by such attributes.

Another interesting aspect of the physics of the problem is that large numbers of DSM units employed in the design of large data storage systems consume a great deal of power. As an example, the table below calculates the power requirements of various numbers of example commercially available disk drives that might be associated with providing various data storage capacities in the TB, PB, and EB range.

Drive Power vs. Storage Capacity
Drive Size: 400 GB
Drive power: 9.5 W (typical)
RAID overhead not considered

| | | Disk Drive Power Dissipation (kW) | | | |
|---|---|---|---|---|---|
| Storage Capacity (PB) | # of drives | R/W | Idle | Standby | Sleep |
| 0.1 | 250 | 2.4 | 2.2 | 0.4 | 0.4 |
| 0.5 | 1,250 | 11.9 | 10.9 | 2.0 | 1.9 |
| 1 | 2,500 | 23.8 | 21.9 | 4.0 | 3.8 |
| 5 | 12,500 | 118.8 | 109.4 | 20.0 | 18.8 |
| 10 | 25,000 | 237.5 | 218.8 | 40.0 | 37.5 |
| 50 | 125,000 | 1,187.5 | 1,093.8 | 200.0 | 187.5 |
| 100 | 250,000 | 2,375.0 | 2,187.5 | 400.0 | 375.0 |
| 500 | 1,250,000 | 11,875.0 | 10,937.5 | 2,000.0 | 1,875.0 |
| 1,000 | 2,500,000 | 23,750.0 | 21,875.0 | 4,000.0 | 3,750.0 |
| 5,000 | 12,500,000 | 118,750.0 | 109,375.0 | 20,000.0 | 18,750.0 |
| 10,000 | 25,000,000 | 237,500.0 | 218,750.0 | 40,000.0 | 37,500.0 |
| 50,000 | 125,000,000 | 1,187,500.0 | 1,093,750.0 | 200,000.0 | 187,500.0 |

As can be seen in the table above developing effective data storage system architectures based on large numbers of disk drives (or other DSM types) presents a significant challenge from a power perspective. As shown, a 50-PB data storage system in continuous-use consumes over 1-MW (mega-watt) of electrical power simply to operate the disk drives. Other system components would only add to this power budget. This represents an extreme waste of electrical power considering the enforced data access characteristics mentioned earlier.

Another interesting aspect of the physics of the problem to be solved is that large numbers of DSM units introduce very significant component failure rate concerns. The equation below shows an example system disk-drive failure rate expressed as a Mean Time Between Failures (MTBF) for a typical inexpensive commodity disk drive. Given that at least 2500 such 400-GB disk drives would be required to provide 1-PB of data storage capacity, the following system failure rate can be calculated.

$$MTBF = 250 \text{,} 000 \frac{drive\_hours}{failure}$$

$$2500 drives = 1 PB$$

$$\begin{matrix}System\_Failure \_Rate = ( 250 \text{,} 000 \frac{drive - hours}{failure} ) ( \frac{system}{2500 drives} ) \\ = ( \frac{250 \text{,} 000}{2 \text{,} 500} ) ( \frac{system - hours}{failure} ) \\ = 100 \frac{system\_hours}{failure} \\ = 4.16 \frac{system - days}{failure}\end{matrix}$$

The following table now presents some example disk-drive (DSM) failure rate calculations for a wide range of system data storage capacities. As can be seen in the table below, the failure rates induced by such a large number of DSM components quickly present some significant design challenges.

Failure Rate vs. Storage Capacity
Drive Size: 400 GB
Drive MTBF: 250k-hours
Drive cost: $300

| | No RAID Overhead | | | | | |
|---|---|---|---|---|---|---|
| | | Calculated | | | | |
| Storage capacity | # of | MTBF | | # drives | # drives | Drive cost |
| (PB) | drives | Hours | Days | per week | per year | per year (k$) |
| 0.1 | 250 | 1000.0 | 41.67 | 0.17 | 8.76 | 2.63 |
| 0.5 | 1,250 | 200.0 | 8.33 | 0.84 | 43.80 | 13.14 |
| 1 | 2,500 | 100.0 | 4.17 | 1.68 | 87.60 | 26.28 |
| 5 | 12,500 | 20.0 | 0.83 | 8.40 | 438.00 | 131.40 |
| 10 | 25,000 | 10.0 | 0.42 | 16.80 | 876.00 | 262.80 |
| 50 | 125,000 | 2.0 | 0.08 | 84.00 | 4,380.00 | 1,314.00 |
| 100 | 250,000 | 1.0 | 0.04 | 168.00 | 8,760.00 | 2,628.00 |
| 500 | 1,250,000 | 0.2 | 0.01 | 840.00 | 4.38E+04 | 13,140.00 |
| 1,000 | 2,500,000 | 0.1 | 0.00 | 1,680.00 | 8.8E+04 | 26,280.00 |
| 5,000 | 12,500,000 | 0.02 | 0.00 | 8,400.00 | 4.4E+05 | 131,400.00 |
| 10,000 | 25,000,000 | 0.01 | 0.00 | 16,800.00 | 8.8E+05 | 262,800.00 |
| 50,000 | 125,000,000 | 0.002 | 0.00 | 84,000.00 | 4.4E+06 | 1,314,000.00 |

Based on the data presented in the table above system designers have generally considered the use of large quantities of disk drives or other similar DSM components to be impractical for the design of large data storage systems. However, as will be subsequently shown, unusual operational paradigms for such large system configurations are possible that exploit the system characteristics described thus far and these paradigms can then enable the development of new and effective data storage system architectures based on enhanced DSM-based RAID methods.

Now, focusing on another class of system-related MTBF issues, the equation below now presents a disk drive failure rate calculation for a single RAID-set.

$$\begin{matrix}RAID\_Set \_Failure \_Rate = ( 250 \text{,} 000 \frac{drive - hours}{failure} ) ( \frac{RAID - set}{32 drives} ) \\ = ( \frac{250 \text{,} 000}{32} ) ( \frac{RAID - set - hours}{failure} ) \\ = 7812 \frac{RAID - set - hours}{failure} \\ = 325 \frac{RAID - set - days}{failure}\end{matrix}$$

The table below then utilizes this equation and provides a series of MTBF calculations for various sizes of RAID-sets in isolation. Although it may appear from the calculations in the table below that RAID-set MTBF concerns are not a serious design challenge, this is generally not the case. Data throughput considerations for any single RAID-controller assigned to manage such large RAID-sets quickly present problems in managing the data-integrity and data-availability of the RAID-set. This observation then highlights another significant design challenge, namely, the issue of how to provide highly scalable, flexible, and dynamically reconfigurable RPC functionality that can provide sufficient capability to effectively manage a large number of large RAID-sets.

Failure rate calculations for various sizes of RAID-6-sets
Drive Size 400 GB
Drive MTBF: 250,000 hours (likely worst case)

| | | | | Other RAID-Set Data | | | |
|---|---|---|---|---|---|---|---|
| | RAID-set Calculated | | | Data Storage | | # RAID- | |
| Size of | MTBF | | | Capacity | | sets | Est. Power |
| RAID-set | Hours | Days | Years | (TB) | Overhead | per PB | (W) |
| 4 | 62500 | 2604.2 | 7.13 | 0.8 | 50.00% | 1250.0 | 38.0 |
| 6 | 41667 | 1736.1 | 4.76 | 1.6 | 33.33% | 625.0 | 57.0 |
| 8 | 31250 | 1302.1 | 3.57 | 2.4 | 25.00% | 416.7 | 76.0 |
| 10 | 25000 | 1041.7 | 2.85 | 3.2 | 20.00% | 312.5 | 95.0 |
| 12 | 20833 | 868.1 | 2.38 | 4.0 | 16.67% | 250.0 | 114.0 |
| 14 | 17857 | 744.0 | 2.04 | 4.8 | 14.29% | 208.3 | 133.0 |
| 16 | 15625 | 651.0 | 1.78 | 5.6 | 12.50% | 178.6 | 152.0 |
| 32 | 7813 | 325.5 | 0.89 | 12.0 | 6.25% | 83.3 | 304.0 |
| 64 | 3906 | 162.8 | 0.45 | 24.8 | 3.13% | 40.3 | 608.0 |
| 128 | 1953 | 81.4 | 0.22 | 50.4 | 1.56% | 19.8 | 1216.0 |
| 256 | 977 | 40.7 | 0.11 | 101.6 | 0.78% | 9.8 | 2432.0 |
| 512 | 488 | 20.3 | 0.06 | 204.0 | 0.39% | 4.9 | 4864.0 |
| 1024 | 244 | 10.2 | 0.03 | 408.8 | 0.20% | 2.4 | 9728.0 |
| 2048 | 122 | 5.1 | 0.01 | 818.4 | 0.10% | 1.2 | 19456.0 |
| 4096 | 61 | 2.5 | 0.01 | 1,637.6 | 0.05% | 0.6 | 38912.0 |

Any large DSM-based data storage system would generally be of little value if the information contained therein were continually subject to data-loss or data-inaccessibility as individual component failures occur. To make data storage systems more tolerant of DSM and other component failures, RAID-methods are often employed to improve data-integrity and data-availability. Various types of such RAID-methods have been defined and employed commercially for some time. These include such widely known methods as RAID 0, 1, 2, 3, 4, 5, 6, and certain combinations of these methods. In short, RAID methods generally provide for increases in system data throughput, data integrity, and data availability. Numerous resources are available on the Internet and elsewhere that describe RAID operational methods and data encoding methods and these descriptions will not be repeated here. However, an assertion is made that large commercially available enterprise-class RAID-systems generally employ RAID-5 encoding techniques because they provide a reasonable compromise among various design characteristics including data-throughput, data-integrity, data-availability, system complexity, and system cost. The RAID-5 encoding method like several others employs a data-encoding technique that provides limited error-correcting capabilities.

The RAID-5 data encoding strategy employs 1 additional “parity” drive added to a RAID-set such that it provides sufficient additional data for the error correcting strategy to recover from 1 failed DSM unit within the set without a loss of data integrity. The RAID-6 data encoding strategy employs 2 additional “parity” drives added to a RAID-set such that it provides sufficient additional data for the error correcting strategy to recover from 2 failed DSM units within the set without a loss of data integrity or data availability.

The table below shows certain characteristics of various sizes of RAID-sets that utilize various generalized error-correcting RAID-like methods. In the table RAID-5 is referred to as “1 parity drive” and RAID-6 is referred to as “2 parity drives”. Additionally, the table highlights some generalized characteristics of two additional error-correcting methods based on the use of 3 and 4 “parity drives”. Such methods are generally not employed in commercial RAID-systems for various reasons including: the general use of small RAID-sets that do not require such extensions, added complexity, increased RPC processing requirements, increased RAID-set error recovery time, and added system cost.

Failure Rate Calculations vs. # RAID “Parity” Drives
Drive Size 400 GB
Drive MTBF: 250,000 hours

| | | Number Of RAID-Set “Parity” Drives | | | | | | | | | | | |
|---|---|---|---|---|---|---|---|---|---|---|---|---|---|
| Size of | | 1 | | | 2 | | | 3 | | | 4 | | |
| RAID- | DSC | USC | RS0 | | USC | RS0 | | USC | RS0 | | USC | RS0 | |
| set | (TB) | (TB) | (%) | RSPP | (TB) | (%) | RSPP | (TB) | (%) | RSPP | (TB) | (%) | RSPP |
| 4 | 1.6 | 1.2 | 25.0 | 833.3 | 0.8 | 50.0 | 1250.0 | | | | | | |
| 5 | 2.0 | 1.6 | 20.0 | 625.0 | 1.2 | 40.0 | 833.3 | | | | | | |
| 6 | 2.4 | 2.0 | 16.7 | 500.0 | 1.6 | 33.3 | 625.0 | 1.2 | 50.0 | 833.3 | | | |
| 7 | 2.8 | 2.4 | 14.3 | 416.7 | 2.0 | 28.6 | 500.0 | 1.6 | 42.9 | 625.0 | | | |
| 8 | 3.2 | 2.8 | 12.5 | 357.1 | 2.4 | 25.0 | 416.7 | 2.0 | 37.5 | 500.0 | 1.6 | 50.0 | 625.0 |
| 10 | 4.0 | 3.6 | 10.0 | 277.8 | 3.2 | 20.0 | 312.5 | 2.8 | 30.0 | 357.1 | 2.4 | 40.0 | 416.7 |
| 12 | 4.8 | 4.4 | 8.3 | 227.3 | 4.0 | 16.7 | 250.0 | 3.6 | 25.0 | 277.8 | 3.2 | 33.3 | 312.5 |
| 14 | 5.6 | 5.2 | 7.1 | 192.3 | 4.8 | 14.3 | 208.3 | 4.4 | 21.4 | 227.3 | 4.0 | 28.6 | 250.0 |
| 16 | 6.4 | 6.0 | 6.3 | 166.7 | 5.6 | 12.5 | 178.6 | 5.2 | 18.8 | 192.3 | 4.8 | 25.0 | 208.3 |
| 32 | 12.8 | 12.4 | 3.1 | 80.6 | 12.0 | 6.3 | 83.3 | 11.6 | 9.4 | 86.2 | 11.2 | 12.5 | 89.3 |
| 64 | 25.6 | 25.2 | 1.6 | 39.7 | 24.8 | 3.1 | 40.3 | 24.4 | 4.7 | 41.0 | 24.0 | 6.3 | 41.7 |
| 128 | 51.2 | 50.8 | 0.8 | 19.7 | 50.4 | 1.6 | 19.8 | 50.0 | 2.3 | 20.0 | 49.6 | 3.1 | 20.2 |
| 256 | 102.4 | 102.0 | 0.4 | 9.8 | 101.6 | 0.8 | 9.8 | 101.2 | 1.2 | 9.9 | 100.8 | 1.6 | 9.9 |
| 512 | 204.8 | 204.4 | 0.2 | 4.9 | 204.0 | 0.4 | 4.9 | 203.6 | 0.6 | 4.9 | 203.2 | 0.8 | 4.9 |
| 1024 | 409.6 | 409.2 | 0.1 | 2.4 | 408.8 | 0.2 | 2.4 | 408.4 | 0.3 | 2.4 | 408.0 | 0.4 | 2.5 |
| 2048 | 819.2 | 818.8 | 0.0 | 1.2 | 818.4 | 0.1 | 1.2 | 818.0 | 0.1 | 1.2 | 817.6 | 0.2 | 1.2 |
| 4096 | 1,638.4 | 1,638.0 | 0.0 | 0.6 | 1,637.6 | 0.0 | 0.6 | 1,637.2 | 0.1 | 0.6 | 1,636.8 | 0.1 | 0.6 |

DSC = Raid-Set Data Storage Capacity
USC = User Data Storage Capacity available
RSO = Raid-Set Overhead
RSPP = Raid-Sets Per PB of user data storage

The methods shown above can be extended well beyond 2 “parity” drives. Although the use of such extended RAID-methods may at first glance appear unnecessary and impractical, the need for such extended methods becomes more apparent in light of the previous discussions presented regarding large system data inaccessibility and the need for increased data-integrity and data-availability in the presence of higher component failure rates and “clustered” failures induced by the large number of components used and the fact that such components will likely be widely distributed to achieve maximum parallelism, scalability, and flexibility.

Considering further issues related to component failure rates and the general inaccessibility of data within large systems as described earlier, the following table presents calculations related to a number of alternate component operational paradigms that exploit the infrequent data access characteristics of large data storage systems. The calculations shown present DSM failure rates under various utilization scenarios. The low end of component utilization shown is a defined minimum value for one example commercially available disk-drive.

RAID-6 System Effective MTBF Based On Uptime
Drive Size: 400 GB (16-drive RAID sets (12.5% overhead))
Drive MTBF: 250,000 hours (worst case)

| | | Usage Rate | | | | | | | |
|---|---|---|---|---|---|---|---|---|---|
| Effective MTBF | | | | | | | | 0.56% | 0.09% |
| k-hours | | 100.0% | 50.0% | 16.7% | 8.3% | 2.4% | 1.2% | 4 hr/30- | 2 hr/90- |
| System | | 24 hr/day | 12 hr/day | 4 hr/day | 2 hr/day | 4 hr/wk | 2 hr/wk | day | day |
| Size | | 250 | 500 | 1,500 | 3,000 | 10,500 | 21,000 | 45,000 | 270,000 |
| (PB) | # of drives | Days/Failure | | | | | | | |
| 0.1 | 281 | 37.04 | 74.07 | 222.2 | 444.4 | 1555.6 | 3111.11 | 6.7E+03 | 4.0E+04 |
| 0.5 | 1,406 | 7.41 | 14.81 | 44.44 | 88.89 | 311.11 | 622.22 | 1.3E+03 | 8.0E+03 |
| 1 | 2,813 | 3.70 | 7.41 | 22.22 | 44.44 | 155.56 | 311.11 | 666.67 | 4.0E+03 |
| 5 | 14,063 | 0.74 | 1.48 | 4.44 | 8.89 | 31.11 | 62.22 | 133.33 | 800.00 |
| 10 | 28,125 | 0.37 | 0.74 | 2.22 | 4.44 | 15.56 | 31.11 | 66.67 | 400.00 |
| 50 | 140,625 | 0.07 | 0.15 | 0.44 | 0.89 | 3.11 | 6.22 | 13.33 | 80.00 |
| 100 | 281,250 | 0.04 | 0.07 | 0.22 | 0.44 | 1.56 | 3.11 | 6.67 | 40.00 |
| 500 | 1,406,250 | 0.01 | 0.01 | 0.04 | 0.09 | 0.31 | 0.62 | 1.33 | 8.00 |
| 1,000 | 2,812,500 | 0.00 | 0.01 | 0.02 | 0.04 | 0.16 | 0.31 | 0.67 | 4.00 |
| 5,000 | 1.4E+07 | 0.00 | 0.00 | 0.00 | 0.01 | 0.03 | 0.06 | 0.13 | 0.80 |
| 10,000 | 2.8E+07 | 0.00 | 0.00 | 0.00 | 0.00 | 0.02 | 0.03 | 0.07 | 0.40 |
| 50,000 | 1.4E+08 | 0.00 | 0.00 | 0.00 | 0.00 | 0.00 | 0.01 | 0.01 | 0.08 |

The important feature of the above table is that, in general, system MTBF figures can be greatly improved by reducing component utilization. Considering that the physics of large data storage systems in the PB/EB range generally prohibit the rapid access to vast quantities of data within such systems, it makes sense to reduce the component utilization related to data that cannot be frequently accessed. The general method described is to place such components in “stand by”, “sleep”, or “power down” modes as available when the data of such components is not in use. This reduces system power requirements and also generally conserves precious component MTBF resources. The method described is applicable to DSM units, controller units, equipment-racks, network segments, facility power zones, facility air conditioning zones, and other system components that can be effectively operated in such a manner.

Another interesting aspect of the physics of the problem to be solved is that the aggregate available data throughput of large RAID-sets grows linearly with increasing RAID-set size and this can provide very high data-throughput rates. Unfortunately, the ability of any single RPC functional unit is generally limited in its RPC data processing and connectivity capabilities. To fully exploit the data throughput capabilities of large RAID-sets highly scalable, flexible, and dynamically reconfigurable RPC utilization methods are required along with a massively parallel component connectivity infrastructure.

The following table highlights various sizes of RAID-sets and calculates effective system data throughput performance as a function of various hypothetical single RPC unit data throughput rates when accessing a RAID array of typical commodity 400-GB disk drives. An interesting feature of the table is that it takes approximately 1.8 hours to read or write a single disk drive using the data interface speed shown. RAID-set data throughput rates exceeding available RPC data throughput rates experience data-throughput performance degradation as well as reduced component error recovery system performance.

RAID System Data Throughput vs. RAID-6 Set Size & RPC Data Throughput
Drive Size: 400 GB
Drive speed: 61 MB/sec

| | | | | | RPC Throughput (MB/sec) | | | | | | | |
|---|---|---|---|---|---|---|---|---|---|---|---|---|
| | | | | | 400 | | 800 | | 1200 | | 2400 | |
| RAID-Set | | | | | Composite RAID-Set & RPC Speed With | | | | | | | |
| size | | | User Data | | Read/Write-Time For The RAID-Set | | | | | | | |
| # | | speed | size | speed | Speed | R/W | Speed | R/W | Speed | R/W | Speed | R/W |
| Drives | TB | MB/s | TB | MB/s | (MB/s) | Hours | (MB/s) | Hours | (MB/s) | Hours | (MB/s) | Hours |
| 4 | 1.6 | 244 | 0.8 | 122 | 244 | 1.8 | 244 | 1.8 | 244 | 1.8 | 244 | 1.8 |
| 6 | 2.4 | 366 | 1.6 | 244 | 366 | 1.8 | 366 | 1.8 | 366 | 1.8 | 366 | 1.8 |
| 8 | 3.2 | 488 | 2.4 | 366 | 400 | 2.2 | 488 | 1.8 | 488 | 1.8 | 488 | 1.8 |
| 10 | 4.0 | 610 | 3.2 | 488 | 400 | 2.8 | 610 | 1.8 | 610 | 1.8 | 610 | 1.8 |
| 12 | 4.8 | 732 | 4.0 | 610 | 400 | 3.3 | 732 | 1.8 | 732 | 1.8 | 732 | 1.8 |
| 14 | 5.6 | 854 | 4.8 | 732 | 400 | 3.9 | 800 | 1.9 | 854 | 1.8 | 854 | 1.8 |
| 16 | 6.4 | 976 | 5.6 | 854 | 400 | 4.4 | 800 | 2.2 | 976 | 1.8 | 976 | 1.8 |
| 32 | 12.8 | 1952 | 12.0 | 1830 | 400 | 8.9 | 800 | 4.4 | 1200 | 3.0 | 1952 | 1.8 |
| 64 | 25.6 | 3904 | 24.8 | 3782 | 400 | 17.8 | 800 | 8.9 | 1200 | 5.9 | 2400 | 3.0 |
| 128 | 51.2 | 7808 | 50.4 | 7686 | 400 | 35.6 | 800 | 17.8 | 1200 | 11.9 | 2400 | 5.9 |
| 256 | 102.4 | 15616 | 102 | 15494 | 400 | 71.1 | 800 | 35.6 | 1200 | 23.7 | 2400 | 11.9 |
| 512 | 204.8 | 31232 | 204 | 31110 | 400 | 142.2 | 800 | 71.1 | 1200 | 47.4 | 2400 | 23.7 |
| 1024 | 409.6 | 62464 | 409 | 62342 | 400 | 284.4 | 800 | 142.2 | 1200 | 94.8 | 2400 | 47.4 |
| 2048 | 819.2 | 124928 | 818 | 124806 | 400 | 568.9 | 800 | 284.4 | 1200 | 189.6 | 2400 | 94.8 |
| 4096 | 1638.4 | 249856 | 1638 | 249734 | 400 | 1137.8 | 800 | 568.9 | 1200 | 379.3 | 2400 | 189.6 |

Error-recovery system performance is important in that it is often a critical resource in maintaining high data-integrity and high data-availability, especially in the presence of high data access rates by external systems. As mentioned earlier it is unlikely that the use of any single centralized high-performance RPC unit will be sufficient to effectively manage PB or EB class data storage system configurations. Therefore, scalable techniques should be employed to effectively manage the data throughput needs of multiple large RAID-sets distributed throughout a large data storage system configuration.

The following table provides a series of calculations for the use of an independent network of RPC nodes working cooperatively together in an effective and efficient manner to provide a scalable, flexible, and dynamically reconfigurable RPC capability within a large RAID-based data storage system. The calculations shown presume the use of commodity 400-GB DSM units within a data storage array, the use of RAID-6 encoding as an example, and the use of the computational capabilities of unused network attached disk controller (NADC) units within the system to provide a scalable, flexible, and dynamically reconfigurable RPC capability to service the available RAID-sets within the system.

An interesting feature of the hypothetical calculations shown is that considering that the number of NADC units expands as the size of the data storage array expands, the distributed block of RPC functionality can be made to scale as well.

RPC System-Level Data Throughput Requirements
Drive Characteristics: size = 400 GB, speed = 61 MB/sec
NADC Characteristics: CPU = 200 MIPS, network = 200 MB/sec

| RAID-Set | | | | | | |
|---|---|---|---|---|---|---|
| size | | | User Data | | NADC requirements for | |
| # | | speed | size | speed | DMRPC functionality | |
| Drives | TB | MB/s | TB | MB/s | NNT | NPP |

| | | | | | | |
|---|---|---|---|---|---|---|
| 4 | 1.6 | 244 | 0.8 | 122 | 1.22 | 244 |
| 6 | 2.4 | 366 | 1.6 | 244 | 1.83 | 366 |
| 8 | 3.2 | 488 | 2.4 | 366 | 2.44 | 488 |
| 10 | 4.0 | 610 | 3.2 | 488 | 3.05 | 610 |
| 12 | 4.8 | 732 | 4.0 | 610 | 3.66 | 732 |
| 14 | 5.6 | 854 | 4.8 | 732 | 4.27 | 854 |
| 16 | 6.4 | 976 | 5.6 | 854 | 4.88 | 976 |
| 18 | 7.2 | 1098 | 6.4 | 976 | 5.49 | 1,098 |
| 20 | 8.0 | 1220 | 7.2 | 1098 | 6.10 | 1,220 |
| 24 | 9.6 | 1464 | 8.8 | 1342 | 7.32 | 1,464 |
| 28 | 11.2 | 1708 | 10.4 | 1586 | 8.54 | 1,708 |
| 32 | 12.8 | 1952 | 12.0 | 1830 | 9.76 | 1,952 |
| 40 | 16.0 | 2440 | 15.2 | 2318 | 12.20 | 2,440 |
| 48 | 19.2 | 2928 | 18.4 | 2806 | 14.64 | 2,928 |
| 56 | 22.4 | 3416 | 21.6 | 3294 | 17.08 | 3,416 |
| 64 | 25.6 | 3904 | 24.8 | 3782 | 19.52 | 3,904 |
| 128 | 51.2 | 7808 | 50.4 | 7686 | 39.04 | 7,808 |
| 256 | 102.4 | 15616 | 101.6 | 15494 | 78.08 | 15,616 |

NNT = NADC network throughput required (in # NADCs)
NPP = NADC processing power available (in MIPS, minimum)

Another interesting aspect of the physics of the problem to be solved is related to the use of high-level network communication protocols and the CPU processing overhead typically experienced by network nodes moving large amounts of data across such networks at high data rates. Simply put, if commonly used communication protocols such as TCP/IP are used as the basis for communication between data storage system components, then it is well-known that moving data at high rates over such communication links can impose a very high CPU processing burden upon the network nodes performing such communication. The following equations and calculations are presented as an example of the CPU overhead. Such equations and calculations are generally seen by Solaris operating system platforms when processing high data rate TCP/IP data transport sessions.

$$System\_Intel \_CPU \_Consumption = ( \frac{1 \text{-} Hz}{( \frac{1 \text{-} bits}{sec} )} ) * ( \frac{N \text{-} bits}{sec} ) = N \text{-} Hz$$

$$System\_Intel \_CPU \_Consumption = ( \frac{1 \text{-} Hz}{( \frac{1 \text{-} bits}{sec} )} ) * ( \frac{2 G \text{-} bits}{sec} ) = 2 \text{-} GHz$$

$$System\_SPARC \_CPU \_Consumption = ( \frac{1 \text{-} Hz}{( \frac{2 \text{-} bits}{sec} )} ) * ( \frac{N \text{-} bits}{sec} ) = \frac{N \text{-} Hz}{2}$$

Stated in textual form, Solaris-Intel platform systems generally experience 1 Hz of CPU performance consumption for every 1 bps (bit-per-second) of network bandwidth used when processing high data transfer rate sessions. In the calculation above a 2 Gbps TCP/IP session would consume 2 GHz of system CPU capability. As can be seen in the calculations above, utilizing such high level protocols for the movement of large RAID-set data can severely impact the CPU processing capabilities of communicating network nodes. Such CPU consumption is generally undesirable and is specifically so when the resources being so consumed are NADC units enlisted to perform RPC duties within a network-centric data storage system. Therefore, more effective means of high-rate data communication are needed.

The following table shows calculations related to the movement of data for various sizes of RAID-sets in various data storage system configurations. Such calculations are example rates related to the use TCP/IP protocols over Ethernet as the infrastructure for data storage system component communication. Other protocols and communication mediums are possible and would generally experience similar overhead properties.

Typical RAID-Set Low-Level Ethernet Packet Rates
RAID-set characteristics: size = 400 GB, speed = 61 MB/sec, 16-drives, RAID-6
Ether packet size std = 1500:jumbo = 9000

| Raw RAID-Set | | | | | | | | |
|---|---|---|---|---|---|---|---|---|
| size | | | | | User Data in RAID-Set | | | |
| # | | speed | Ethernet Packet Rate | | size | speed | Ethernet Packet Rate | |
| Drives | TB | MB/s | SEPR | JEPR | TB | MB/s | SEPR | JEPR |
| 4 | 1.6 | 244 | 162,667 | 27,111 | 0.8 | 122 | 81,333 | 13,556 |
| 6 | 2.4 | 366 | 244,000 | 40,667 | 1.6 | 244 | 162,667 | 27,111 |
| 8 | 3.2 | 488 | 325,333 | 54,222 | 2.4 | 366 | 244,000 | 40,667 |
| 10 | 4.0 | 610 | 406,667 | 67,778 | 3.2 | 488 | 325,333 | 54,222 |
| 12 | 4.8 | 732 | 488,000 | 81,333 | 4.0 | 610 | 406,667 | 67,778 |
| 14 | 5.6 | 854 | 569,333 | 94,889 | 4.8 | 732 | 488,000 | 81,333 |
| 16 | 6.4 | 976 | 650,667 | 108,444 | 5.6 | 854 | 569,333 | 94,889 |
| 18 | 7.2 | 1098 | 732,000 | 122,000 | 6.4 | 976 | 650,667 | 108,444 |
| 20 | 8.0 | 1220 | 813,333 | 135,556 | 7.2 | 1098 | 732,000 | 122,000 |
| 24 | 9.6 | 1464 | 976,000 | 162,667 | 8.8 | 1342 | 894,667 | 149,111 |
| 28 | 11.2 | 1708 | 1,138,667 | 189,778 | 10.4 | 1586 | 1,057,333 | 176,222 |
| 32 | 12.8 | 1952 | 1,301,333 | 216,889 | 12.0 | 1830 | 1,220,000 | 203,333 |
| 40 | 16.0 | 2440 | 1,626,667 | 271,111 | 15.2 | 2318 | 1,545,333 | 257,556 |
| 48 | 19.2 | 2928 | 1,952,000 | 325,333 | 18.4 | 2806 | 1,870,667 | 311,778 |
| 56 | 22.4 | 3416 | 2,277,333 | 379,556 | 21.6 | 3294 | 2,196,000 | 366,000 |
| 64 | 25.6 | 3904 | 2,602,667 | 433,778 | 24.8 | 3782 | 2,521,333 | 420,222 |
| 128 | 51.2 | 7808 | 5,205,333 | 867,556 | 50.4 | 7686 | 5,124,000 | 854,000 |
| 256 | 102.4 | 15616 | 10,410,667 | 1,735,111 | 101.6 | 15494 | 10,329,333 | 1,721,556 |

SEPR = Standard Ethernet packet (1500 bytes) rate (packets per second)
JEPR = Jumbo Ethernet packet (9000 bytes) rate (packets per second)

As mentioned earlier effective distributed data storage systems capable of PB or EB data storage capacities will likely be characterized by various “zones” that reflect different operational capabilities associated with the access characteristics of the data being stored. Typically, it is expected that the most common operational capability that will be varied is data throughput performance. Given the assumption of a standard network communication infrastructure being used by all data storage system components it is then possible to make some assumptions about the anticipated performance of typical NADC unit configurations. Based on these configurations various calculations can be performed based on estimates of data throughput performance between the native DSM interface, the type of NADC network interfaces available, the number of NADC network interfaces available, and the capabilities of each NADC to move data across these network or data communication interfaces.

The following table presents a series of calculations based on a number of such estimated values for method illustration purposes. A significant feature of the calculations shown in this table is that NADC units can be constructed to accommodate various numbers of attached DSM units. In general, the larger the number of attached DSM units per unit of NADC network bandwidth, the lower of the performance of the overall system configuration that employs such units and this generally results in a lower overall data storage system cost.

NADC Data
Drive Size 400 GB: Drive throughput 61 MB/sec: 16-Drive
RAID-6 overhead included (where applicable)

| | | NADC Characteristics | | | |
|---|---|---|---|---|---|
| | | DPN | | | |
| | | 4 | 8 | 16 | 32 |
| | | SDT | | | |
| | | 244 | 488 | 976 | 1952 |
| Storage | | DNR | | | |
| capacity | # of | 1.22 | 2.44 | 4.88 | 9.76 |
| (PB) | drives | NUR | NUR | NUR | NUR |
| 0.5 | 1,406 | 352 | 176 | 88 | 44 |
| 1 | 2,813 | 704 | 352 | 176 | 88 |
| 2 | 5,625 | 1,407 | 704 | 352 | 176 |
| 5 | 14,063 | 3,516 | 1,758 | 879 | 440 |
| 10 | 28,125 | 7,032 | 3,516 | 1,758 | 879 |
| 15 | 42,188 | 10,547 | 5,274 | 2,637 | 1,319 |
| 20 | 56,250 | 14,063 | 7,032 | 3,516 | 1,758 |
| 30 | 84,375 | 21,094 | 10,547 | 5,274 | 2,637 |
| 40 | 112,500 | 28,125 | 14,063 | 7,032 | 3,516 |
| 50 | 140,625 | 35,157 | 17,579 | 8,790 | 4,395 |
| 60 | 168,750 | 42,188 | 21,094 | 10,547 | 5,274 |
| 70 | 196,875 | 49,219 | 24,610 | 12,305 | 6,153 |
| 80 | 225,000 | 56,250 | 28,125 | 14,063 | 7,032 |
| 90 | 253,125 | 63,282 | 31,641 | 15,821 | 7,911 |
| 100 | 281,250 | 70,313 | 35,157 | 17,579 | 8,790 |

DPN = Drives per NADC
SDT = Combined SATA Disk Data Throughput (MB/sec)
DNR = Disk-to-Network Throughput Ratio
NUR = Number of NADC Units Required

Another interesting aspect of the physics involved in developing effective PB/EB class data storage systems is related to equipment physical packaging concerns. Generally accepted commercially available components employ a horizontal sub-unit packaging strategy suitable for the easy shipment and installation of small boxes of equipment. Smaller disk drive modules are one example. Such sub-units are typically tailored for the needs of small RAID-system installations. Larger system configurations are then generally required to employ large number of such units. Unfortunately, such a small-scale packaging strategy does not scale effectively to meet the needs of PB/EB-class data storage systems.

The following table presents a series of facility floorspace calculations for an example vertically-arranged and volumetrically efficient data storage equipment rack packaging method as shown in drawings. Such a method may be suitable when producing PB/EB-class data storage system configurations.

PB-Class Facility Floorspace Requirements
Estimates assume 12 racks/PB
Estimates assume ˜6.0 sq-ft of floorspace per rack
Estimates assume 48″ aisle width between racks

| Storage capacity | | Rack | Aisle | Rack + Aisle | Rack + Aisle |
|---|---|---|---|---|---|
| (PB) | Racks | (sq-ft) | (sq-ft) | (sq-ft) | (acres) |
| 0.5 | 6 | 40.5 | 54.0 | 94.5 | 0.002 |
| 1 | 12 | 81.0 | 108.0 | 189.0 | 0.004 |
| 2 | 24 | 162.0 | 216.0 | 378.0 | 0.009 |
| 5 | 60 | 405.0 | 540.0 | 945.0 | 0.022 |
| 10 | 120 | 810.0 | 1,080.0 | 1,890.0 | 0.043 |
| 50 | 600 | 4,050.0 | 5,400.0 | 9,450.0 | 0.217 |
| 100 | 1,200 | 8,100.0 | 10,800.0 | 18,900.0 | 0.434 |
| 500 | 6,000 | 40,500.0 | 54,000.0 | 94,500.0 | 2.169 |
| 1,000 | 12,000 | 81,000.0 | 108,000.0 | 189,000.0 | 4.339 |
| 5,000 | 60,000 | 405,000.0 | 540,000.0 | 945,000.0 | 21.694 |
| 10,000 | 120,000 | 810,000.0 | 1,080,000.0 | 1,890,000.0 | 43.388 |
| 50,000 | 600,000 | 4,050,000.0 | 5,400,000.0 | 9,450,000.0 | 216.942 |

Another interesting aspect of the physics involved in developing effective PB/EB class data storage systems is related to the effective use of facility resources. The table below provides a series of calculations for estimated power distribution and use as well as heat dissipation for various numbers of data storage equipment racks providing various amounts of data storage capacity. Note that the use of RAID-6 sets is only presented as an example.

NCRSS Facility Power Required for Disk Storage Racks (estimate)
Drive Size: 400 GB (16-drive RAID sets (12.5% overhead))
Drive power: 9.5 W
Rack info: 240 drives/rack
Power conversion efficiency: 90% (estimated)

| | RAID-Array Information | | | | Total Rack Power Required | | | |
|---|---|---|---|---|---|---|---|---|
| System | | Disk | Disk | | 120 V | 240 V | 208 V | |
| Size | # | power | power | # | 1-Ph | 1-Ph | 3-Ph | 48 V DC |
| (PB) | Disks | (kW) | (BTU) | Racks | (A) | (A) | (A) | (A) |
| 0.5 | 1,406 | 14.8 | 51 | 5.9 | 124 | 62 | 38 | 309 |
| 1 | 2,813 | 29.7 | 101 | 11.7 | 247 | 124 | 76 | 618 |
| 5 | 14,063 | 148.4 | 506 | 58.6 | 1,237 | 618 | 381 | 3,092 |
| 10 | 28,125 | 296.9 | 1,013 | 117.2 | 2,474 | 1,237 | 762 | 6,185 |
| 50 | 140,625 | 1,484.4 | 5,065 | 585.9 | 12,370 | 6,185 | 3,810 | 30,924 |
| 100 | 281,250 | 2,968.8 | 10,129 | 1,171.9 | 24,740 | 12,370 | 7,620 | 61,849 |
| 500 | 1,406,250 | 14,843.8 | 50,647 | 5,859.4 | 123,698 | 61,849 | 38,099 | 309,245 |
| 1,000 | 2,812,500 | 29,687.5 | 101,294 | 11,718.8 | 247,396 | 123,698 | 76,198 | 618,490 |
| 5,000 | 14,062,500 | 148,437.5 | 506,469 | 58,593.8 | 1,236,979 | 618,490 | 380,990 | 3,092,448 |
| 10,000 | 28,125,000 | 296,875.0 | 1,012,938 | 117,187.5 | 2,473,958 | 1,236,979 | 761,979 | 6,184,896 |

An important point shown by the calculated estimates provide above is that significant amounts of power are consumed and heat generated by such large data storage system configurations. Considering the observations presented earlier regarding enforced infrequent data access we can therefore observe that facility resources such as electrical power, facility cooling airflow, and other factors should be conserved and effectively rationed so that operational costs of such systems can be minimized.

### BRIEF DESCRIPTION OF THE DRAWINGS

FIG. 1 is a block diagram of a distributed processing RAID system architecture according to the present disclosure.

FIG. 2 is a logical block diagram of a distributed processing RAID system architecture according to the present disclosure.

FIG. 3 is a high-level logical block diagram of a network attached disk controller architecture according to the present disclosure.

FIG. 4 is a detailed block diagram of the network attached disk controller of figure three.

FIG. 5 is a logical block diagram of a typical data flow scenario for a distributed processing RAID system architecture according to the present disclosure.

FIG. 6 is a block diagram of a the flow for a distributed processing RAID system architecture showing RPC aggregation and an example error-recovery operational scenario according to the present disclosure.

FIG. 7 is a logical block diagram of a single NADC unit according to the present disclosure.

FIG. 8 is a logical block diagram of a single low-performance RAID-set configuration of 16 DSM units evenly distributed across 16 NADC units.

FIG. 9 is a logical block diagram of 2 independent RAID-set configurations distributed within an array of 16 NADC units.

FIG. 10 is a logical block diagram showing a single high-performance RAID-set configuration consisting of 64 DSM units evenly distributed across 16 NADC units.

FIG. 11 is a logical block diagram of a 1-PB data storage array with 3 independent RAID-set configurations according to the present disclosure.

FIG. 12 is a logical block diagram of an array of 4 NADC units organized to provide aggregated RPC functionality.

FIG. 13 is a timing diagram showing the RPC aggregation method of FIG. 12.

FIG. 14 is a logical block diagram of an array of 8 NADC units organized to provide aggregated RPC functionality that is an extension of FIG. 12.

FIG. 15 is a block diagram of a possible-component configuration for a distributed processing RAID system component configuration when interfacing with multiple external client computer systems.

FIG. 16 is a block diagram of a generally high performance component configuration for a distributed processing RAID system configuration when interfacing with multiple external client computer systems.

FIG. 17 is a block diagram of a generally low performance component configuration incorporating multiple variable performance capabilities owns within a distributed processing RAID system configuration when interfacing with multiple external client computer systems.

FIG. 18 is a block diagram of an example PCI card that can be used to minimize the CPU burden imposed by high-volume data transfers generally associated with large data storage systems.

FIG. 19 is a logical block diagram of 2 high-speed communication elements while employing a mix of high-level and low-level network communication protocols over a network communication medium.

FIG. 20 is a block diagram of a data storage equipment rack utilizing a vertically arranged internal component configuration enclosing large numbers of DSM units.

FIG. 21 is a block diagram of one possible data storage rack connectivity configuration when viewed from a power, network distribution, environmental sensing, and environmental control perspective according to the present disclosure.

FIG. 22 is a block diagram of certain software modules relevant to providing high-level RAID control system functionality.

FIG. 23 is a block diagram of certain software modules relevant to providing high-level meta-data management system functionality.

### DETAILED DESCRIPTION OF THE INVENTIONS

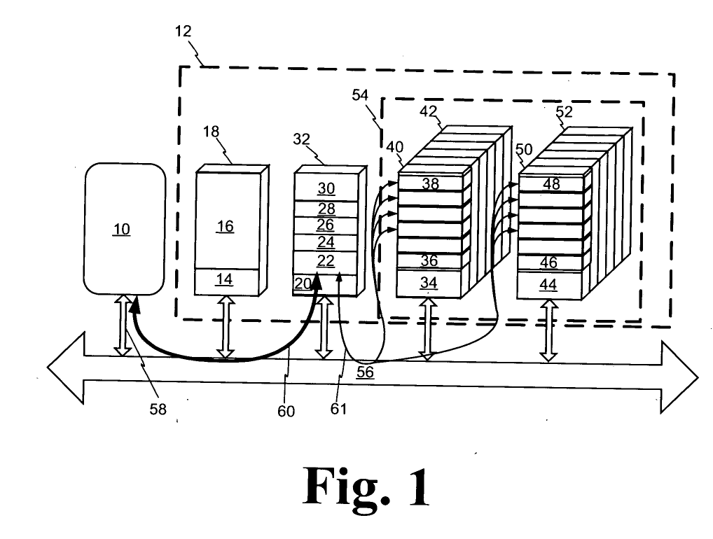

Referring to FIG. 1, a high-level block diagram of a scalable distributed processing network-centric RAID system architecture is shown. Network link 56 is any suitable extensible network communication system such as an Ethernet (ENET), Fibre-Channel (FC), or other data communication network. Network link 58 is representative of several of the links shown connecting various components to the network 56. Client computer system (CCS) 10 communicates with the various components of RAID system 12. Equipment rack 18 encloses network interface and power control equipment 14 and a meta-data management system (MDMS) components 16. Equipment rack 32 encloses network interface and power control equipment 20, several RPC units (22 through 28), and a RAID control and management system (RCS) 30. Block 54 encloses an array of data storage equipment racks shown as 40 through 42 and 50 through 52. Each data storage equipment rack is shown to contain network interface and power control equipment such as 34 or 44 along with a number of network attached data storage bays shown representatively as 36 through 38 and 46 through 48. Note that the packaging layout shown generally reflects traditional methods used in industry today.

Arrow 60 shows the most prevalent communication path by which the CCS 10 interacts with the distributed processing RAID system. Specifically, arrow 60 shows data communications traffic to various RPC units (22 through 28) within the system 12. Various RPC units interact with various data storage bays within be distributed processing RAID system as shown by the arrows representatively identified by 61. Such interactions generally performed disk read or write operations as requested by the CCS 10 and according to the organization of the specific RAID-set or raw data storage volumes being accessed.

The data storage devices being managed under RAID-system control need not be limited to conventional rotating media disk drives. Any form of discrete data storage modules such as magnetic, optical, semiconductor, or other data storage module (DSM) is a candidate for management by the RAID system architecture disclosed.

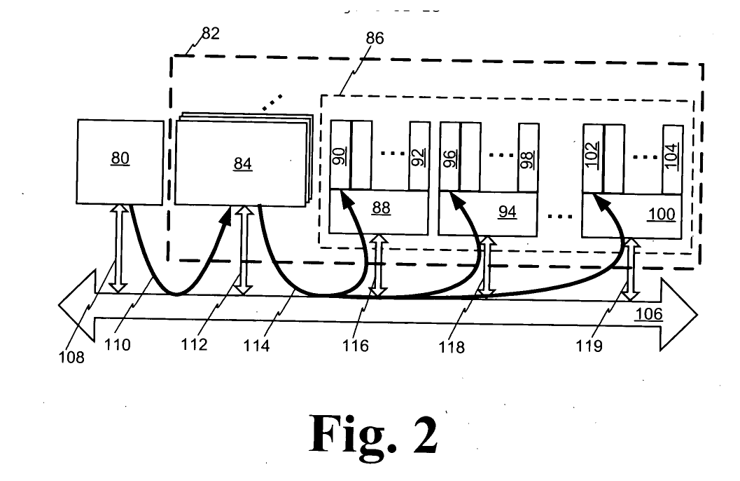

Referring to FIG. 2, a logical view of a distributed processing network-centric RAID system architecture is shown. Network interface 106 is some form of extensible network communication system such as an Ethernet (ENET), Fibre-Channel (FC), or other physical communication medium that utilizes Internet protocol or some other form of extensible communication protocol. Data links 108, 112, 116, 118, and 119 are individual network communication links that connect the various components shown to the larger extensible network 106. Client Computer System (CCS) 80 communicates with the RAID system 82 that encompasses the various components of the distributed processing RAID system shown. A plurality of RPC units 84 are available on the network to perform RAID management functions on behalf of a CCS 80. Block 86 encompasses the various components of the RAID system shown that directly manage DSMs and are envisioned to generally reside in separate data storage equipment racks or other enclosures. A plurality of network attached disk controller (NADC) units represented by 88, 94, and 100 connect to the network 106. Each NADC unit is responsible for managing some number of attached DSM units. As an example, NADC unit 88 is shown managing a plurality of attached DSM units shown representatively as 90 through 92. The other NADC units (94 and 100) are shown similarly managing their attached DSM units shown representatively as 96 through 98 and 102 through 104, respectively.

The thick arrows 110 and 114 represent paths of communication and predominant data flow. The direction of the arrows shown is intended to illustrate the predominant dataflow as might be seen when a CCS 80 writes data to the various DSM elements of a RAID-set shown representatively as 90, 96, and 102. The number of possible DSM units that may constitute a single RAID-set using the distributed processing RAID system architecture shown is scalable and is largely limited only by the number of NADC-DSM units 86 that can be attached to the network 106 and effectively accessed by RPC units 84.

As an example, arrow 110 can be described as taking the form of a CCS 80 write-request to the RAID system. In this example, a write-request along with the data to be written could be directed to one of the available RPC units 84 attached to the network. A RPC unit 84 assigned to manage the request stream could perform system-level, storage-volume-level, and RAID-set level management functions. As a part of performing these functions these RPC units would interact with a plurality of NADC units on the network (88, 94, 100) to write data to the various DSM units that constitute the RAID-set of interest here shown as 90, 96, and 102. Should a CCS 80 issue a read-request to the RAID system a similar method of interacting with the components described thus far could be performed, however, the predominant direction of dataflow would be reversed.

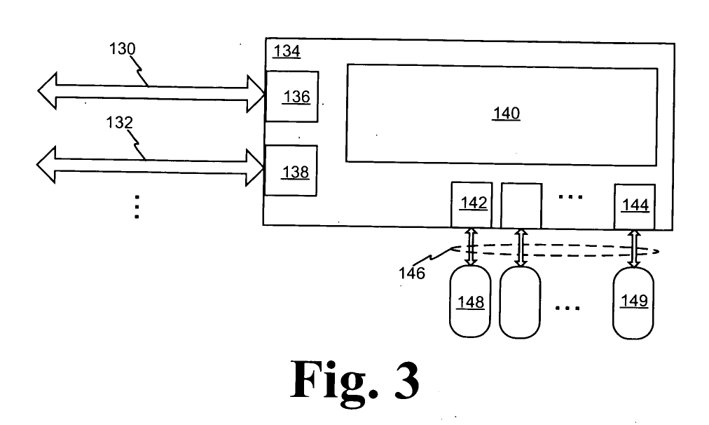

Referring to FIG. 3, a Network-Attached Disk Controller (NADC) 134 architecture subject to the present disclosure, a high-level block diagram is shown. NADC units are envisioned to have one or more network communication links. In this example two such links are shown represented here by 130 and 132. NADC units communicating over such links are envisioned to have internal communication interface circuitry 136 and 138 appropriate for the type of communication links used. NADC units are also envision to include interfaces for to one or more disk drives, semiconductor-based data storage devices, or other forms of Data Storage Module (DSM) units here shown as 148 through 149. To communicate with these attached DSM units, an NADC unit 134 is envisioned to include one or more internal interfaces (142 through 144) to support communication with and the control of electrical power to the external DSM units (148 through 149). The communication link or links used to connect an NADC with the DSM units being managed is shown collectively by 146. The example shown assumes the need for discrete communication interfaces for each attached DSM, although other interconnect mechanisms are possible. NADC management and control processing functions are shown by block 140.

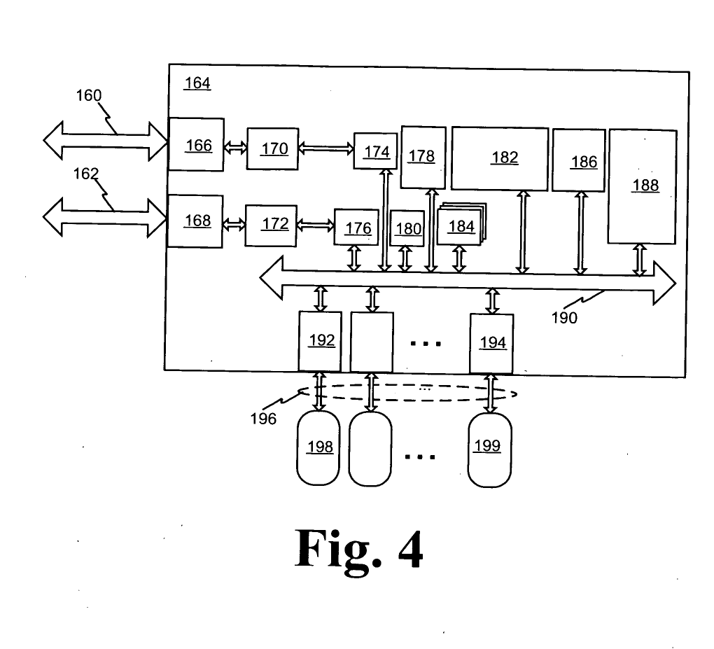

Referring to FIG. 4, a Network-Attached Disk Controller (NADC) 164 is shown in more detail. NADC units of this type are envisioned to be high-performance data processing and control engines. A plurality of local computing units (CPUs) 184 are shown attached to an internal bus structure 190 and are supported by typical RAM and ROM memory 188 timing and control supporting circuits 178. One or more DSM units shown representatively as 198 through 199 are attached to and managed by the NADC 164. The NADC local CPUs 184 communicate with the external DSM units via one or more interfaces shown representatively as 192 through 194 and the DSM communication links here shown as 196 collectively.

NADC units are envisioned to have one or more network communication links shown here as 160 and 162. The NADC local CPUs communicate over these network communication links via one or more interfaces here shown as the pipelines of components 166-170-174, and 168-172-176. Each pipeline of components represents typical physical media, interface, and control logic functions associated with each network interface. Examples of such interfaces include Ethernet, FC, and other network communication mediums.

To assist the local CPU(s) in performing their functions in a high-performance manner the certain components are shown to accelerate NADC performance. A high-performance DMA device is 180 used to minimize the processing burden typically imposed by moving large blocks of data at high rates. A network protocol accelerator 182 module enables faster network communication. Such circuitry could improve the processing performance of the TCP-IP communication protocol. An RPC acceleration module 186 could provide hardware support for more effective and faster RAID-set data management in high-performance RAID system configurations

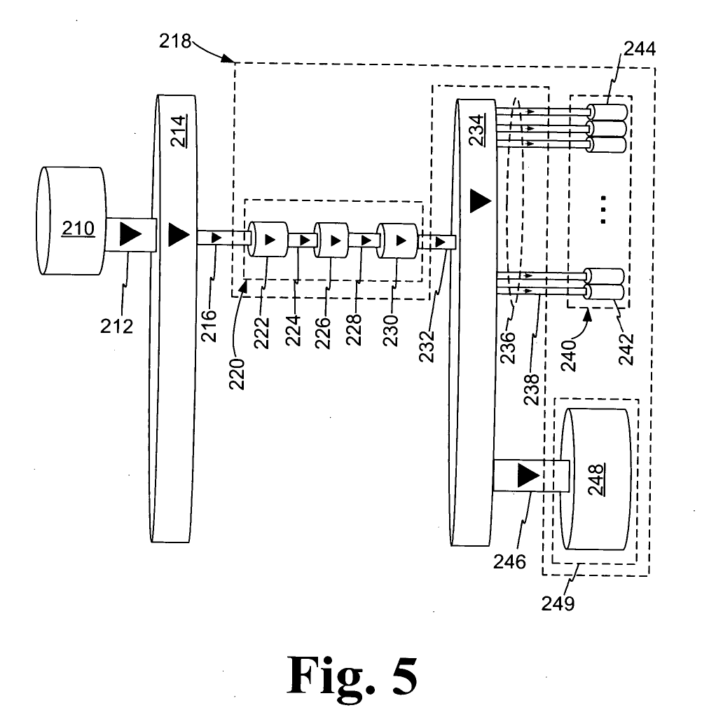

Referring to FIG. 5, a distributed processing RAID system architecture subject to the current disclosure is shown represented by a high-level logical “pipeline” view of possible dataflow. In this figure various pipe-like segments are shown for various RAID system components where system-component and data-link diameters generally reflect typical segment data throughput capabilities relative to one another. Predominant dataflow is represented by the triangles within the segments. The major communication network 214 and 234 connects system RAID system components. The components of the network centric RAID system are shown enclosed by 218. The example shown represents the predominant dataflow expected when a Client Computer System (CCS) 210 writes data to a RAID-set shown as 240. The individual DSM units and NADC units associated with the RAID-set are shown representatively as 242 through 244.

As a simple example, a write-process is initiated when a CCS 210 attached to the network issues a write-request to RPC 220 to perform a RAID-set write operation. This request is transmitted over the network along the path 212-214-216. The RPC 220 is shown connected to the network via one or more network links with dataflow capabilities over these links shown as 216 and 232. The RPC managing the write-request performs a network-read 222 of the data from the network and it transfers the data internally for subsequent processing 224. At this point the RPC 220 must perform a number of internal management functions 226 that include disaggregating the data stream for distribution to the various NADC and DSM units that form the RAID-set of interest, performing other “parity” calculations for the RAID-set as necessary, managing the delivery of the resulting data to the various NADC-DSM units, managing the overall processing workflow to make sure all subsequent steps are performed properly, and informing the CCS 210 as to the success or failure of the requested operation. Pipeline item 228 represents an internal RPC 220 data transfer operation. Pipeline item 230 represents multiple RPC network-write operations. Data is delivered from the RPC to the RAID-set NADC-DSM units of interest via network paths such as 232-234-238.

The figure also shows an alternate pipeline view of a RAID set such as 240 where the collective data throughput capabilities of 240 are shown aggregated as 248 and the boundary of the RAID-set is shown as 249. In this case the collective data throughput capability of RAID-set 240 is shown as 236. A similar collective data throughput capability for RAID-set 248 is shown as the aggregate network communication bandwidth shown as 246.

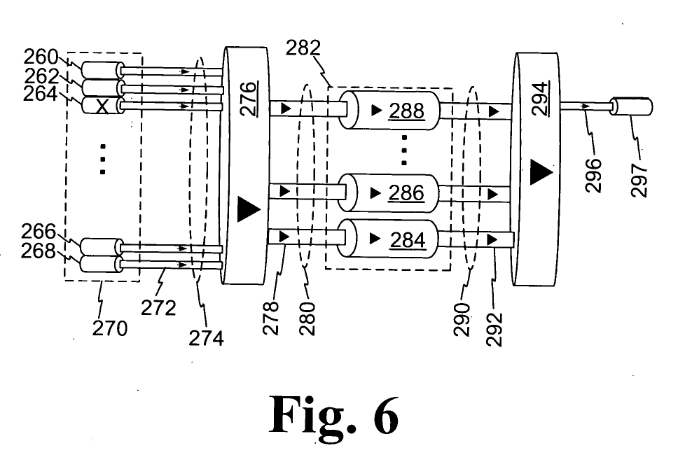

Referring to FIG. 6, a distributed processing RAID system architecture subject to the current disclosure is shown represented by a high-level logical “pipeline” view of RAID-set dataflow in an error-recovery scenario. In this figure various pipe-like segments are shown for various RAID system components where system-component and data-link diameters generally reflect typical segment data throughput capabilities relative to one another. Predominant dataflow is represented by the triangles within the segments. The major communication network 276 and 294 connects system RAID system components.

Individual RPC network links are shown representatively as 278 and 292. The aggregate network input and output capabilities of an aggregated logical-RPC (LRPC) 282 is shown as 280 and 290 respectively. A predominant feature of this figure is the aggregation of the capabilities of a number of individual RPC units 284, and 286 through 288 attached to the network to form a single aggregated logical block of RPC functionality shown as 282. An example RAID-set 270 is shown that consist of an arbitrary collection of “N” NADC-DSM units initially represented here as 260 through 268. Data link 272 representatively shows the connection of the NADC units to the larger network. The aggregate bandwidth of these NADC network connections is shown as 274.

Another interesting feature of this figure is that it shows the processing pipeline involved in managing an example RAID-5 or RAID-6 DSM set 270 in the event of a failure of a member of the RAID-set here shown as 264. To properly recover from a typical DSM failure would likely involve the allocation of an available DSM from somewhere else on the network within the distributed RAID system such as that shown by the NADC-DSM 297. The network data-link associated with NADC-DSM is shown by 296. To adequately restore the data integrity of the example RAID-set 270 would involve reading the data from remaining good DSMs within the RAID-set 270, recomputing the contents of the failed DSM 264, writing the contents of the data stream generated to the newly allocated DSM 297, and then redefining the RAID-set 270 so that it now consists of NADC-DSM units 260, 262, 297, through 266 and 268. The high data throughput demands of such error recovery operations exposes the need for the aggregated LRPC functionality represented by 282.

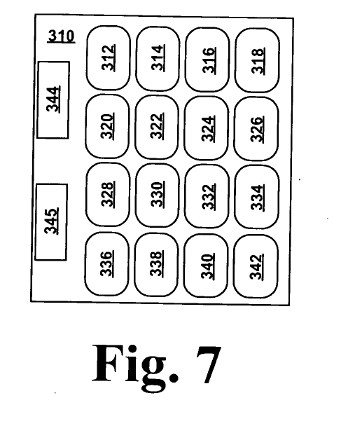

Referring to FIG. 7, a typical NADC unit subject to the current disclosure, the block diagram shown represents the typical functionality presented to the network by a NADC unit with a number of attached DSM units. In this figure this block of NADC-DSM functionality 310 shows sixteen DSM units (312 through 342) attached to the NADC 310. In this example two NADC network interfaces are shown as 344 and 345. Such network interfaces could typically represent Ethernet interfaces, FC interfaces, or other types of network communication interfaces.

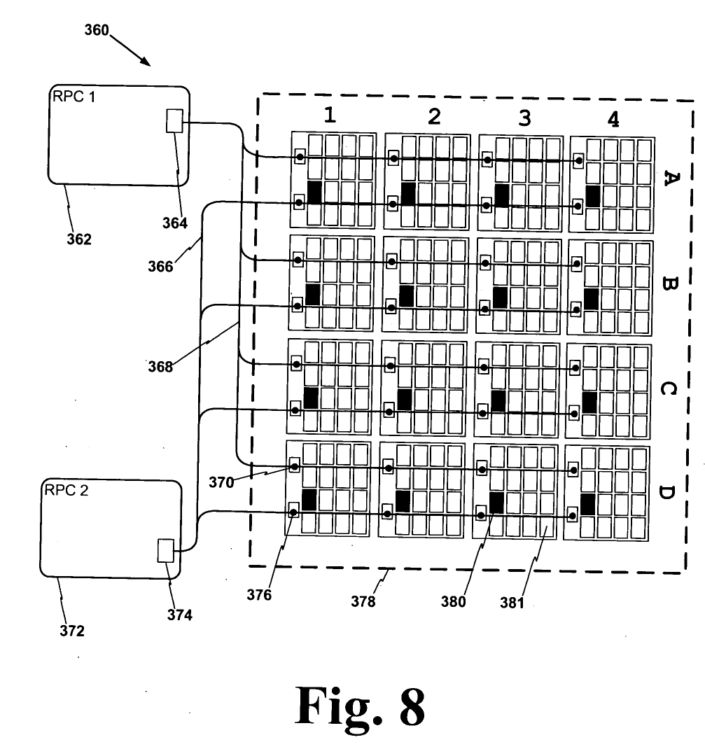

Referring to FIG. 8, a small distributed processing RAID system component configuration 360 subject to the present disclosure is shown. The block diagram shown represents a 4×4 array of NADC units 378 arranged to present an array of data storage elements to the RAID-system network. In this example a RAID-set is formed by sixteen DSM units that are distributed widely across the array of NADC units. The DSM units that comprise this RAID-set are shown representatively as 380. Those DSM units not a part of the RAID-set of interest are shown representatively as 381.

Given an array of NADC units with dual network attachment points (370 and 376) such as that shown in FIG. 7, it is possible that two or more RPC units shown representatively as 362 and 372 could communicate with the various NADC-DSM units that comprise this RAID-set. In this example RPC unit 362 communicates with the 4×4 array of NADC units via the network communication link 368. RPC unit 372 similarly communicates via network communication link 366. Such a RAID-set DSM and network connectivity configuration can provide a high degree of data-integrity and data-availability.

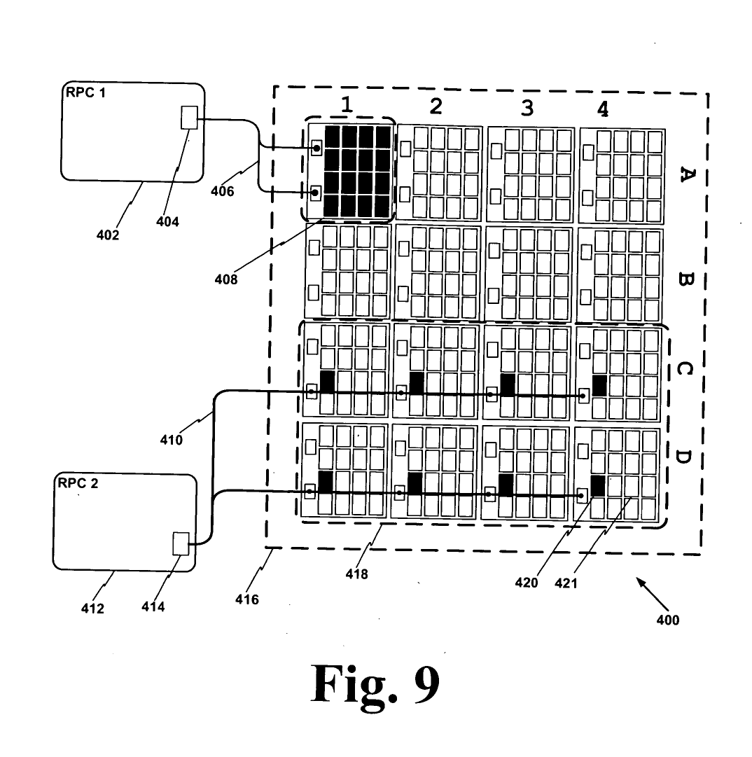

Referring to FIG. 9, a small distributed processing RAID system component configuration 400 subject to the present disclosure is shown. The block diagram shown represents a 4×4 array of NADC units 416 arranged to present an array of data storage elements to the RAID-system network. In this example two independent RAID-sets are shown distributed across the NADC array. RAID-set 408 is a set of sixteen DSM units attached to a single NADC unit at grid coordinate “1A”. RAID-set 418 is a set of eight DSM units attached to the group of eight NADC units in grid rows “C” and “D”. The DSM units that comprise the two RAID-sets are shown representatively as 420. Those DSM units not a part of the RAID-sets of interest in this example are shown representatively as 421.

In this example two RPC units (402 and 412) each manage an independent RAID-set within the array. The connectivity between RPC 402 and RAID-set 408 is shown to be logically distinct from other activities using the network connectivity provided by 406 and utilizing both NADC network interfaces shown for the NADC within 408 for potentially higher network data throughput capabilities. This example presumes that the network interface capability 404 of RPC 402 could be capable of effectively utilizing the aggregate NADC network data throughput. RPC unit 412 is shown connected via the network interface 414 and the logical network link 410 to eight NADC units. In some network configurations such an approach could provide RPC 412 with a RAID-set network throughput equivalent to the aggregate bandwidth of all eight NADC units associated with RAID-set 418. This example presumes that the network interface capability of 414 for RPC 412 could be capable of effectively utilizing such aggregate RAID-set network data throughput.

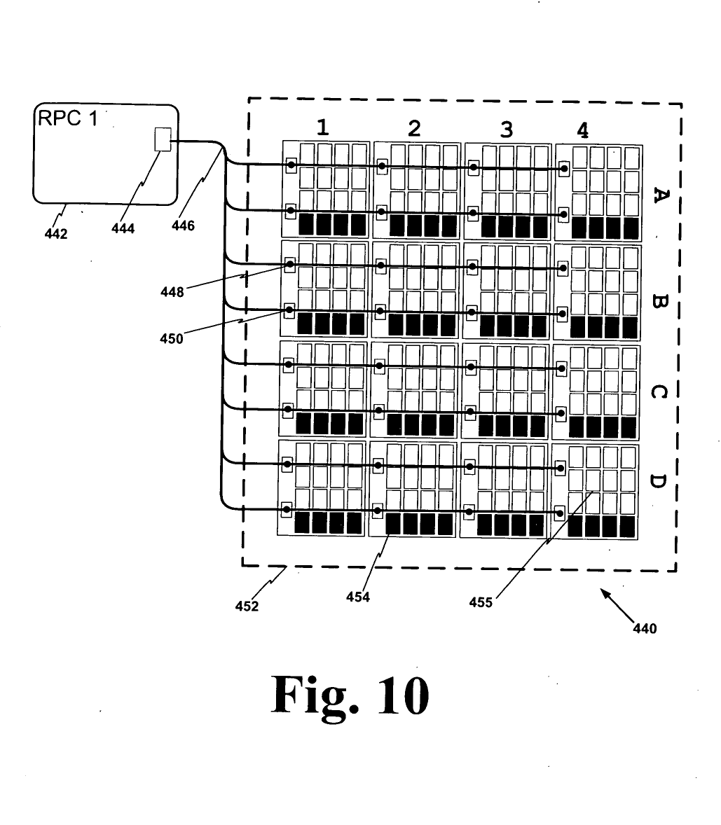

Referring to FIG. 10, a small distributed processing RAID system component configuration 440 subject to the present disclosure is shown. The block diagram shown represents a 4×4 array of NADC units 452 arranged to present an array of data storage elements to the RAID-system network. In this example one generally high-performance RAID-set is shown as a set of sixty-four DSM units attached to and evenly distributed across the sixteen-NADC units throughout the NADC array. The DSM units that comprise the RAID-set shown are representatively shown as 454. Those DSM units not a part of the RAID-set of interest in this example are shown representatively as 455.

In this example one high-performance RPC unit 442 is shown managing the RAID-set. The connectivity between RPC 442 and RAID-set elements within 452 is shown via the network link 446 and this network utilizes both NADC network interfaces shown for all NADC units within 452. Such NADC network interface connections are shown representatively as 448 and 450. Such a network connectivity method generally provides an aggregate data throughput capability for the RAID-set equivalent to thirty-two single homogeneous NADC network interfaces. Where permitted by the network interface capability 444 available, RPC 442 could be capable of utilizing the greatly enhanced aggregate NADC network data throughput to achieve very high RAID-set and system data throughput performance levels. In some network and DSM configurations such an approach could provide RPC 442 with greatly enhanced RAID-set data throughput performance. Although high in data throughput performance, we note that the organization of the RAID-set shown within this example is less than optimal from a data-integrity and data-availability perspective because a single NADC failure could deny access to four DSM units.

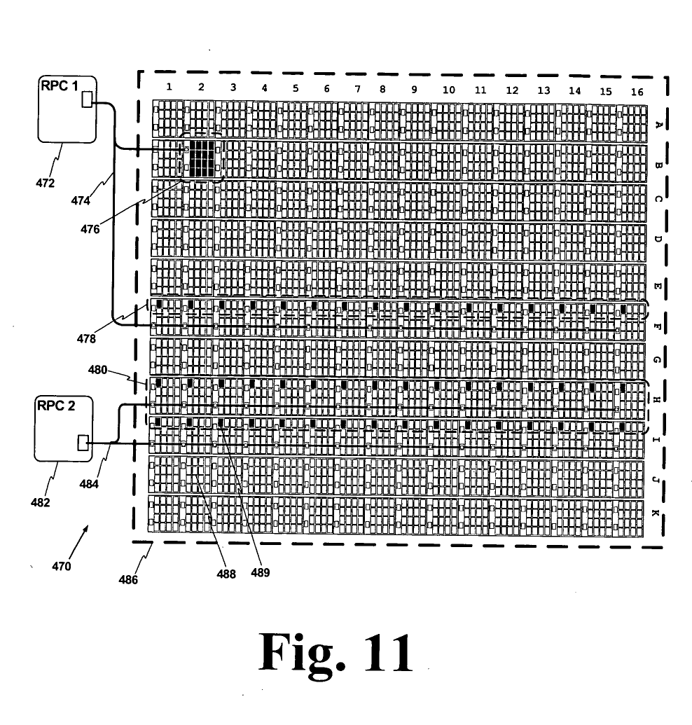

Referring to FIG. 11, a larger distributed processing RAID system component configuration 470 subject to the present disclosure is shown. The block diagram shown represents a 16×11 array of NADC units 486 arranged to present an array of data storage elements to a RAID-system network. The intent of the figure is to show a large 1-PB distributed processing RAID system configuration within the array 486. In this configuration one hundred seventy six NADC units 486 are available to present an array of data storage elements to the network. If the DSM units shown within this array have a data storage capacity of 400 GB each, then the total data storage capacity of the NADC-DSM array shown 486 is approximately 1-PB.

In this example three independent RAID-sets are shown within the NADC array. RAID-set 476 is a set of sixteen DSM units attached to the single NADC at grid coordinate “2B”. RAID-set 478 is a set of sixteen DSM units evenly distributed across an array of sixteen NADC units in grid row “F”. RAID-set 480 is a set of thirty-two DSM units evenly distributed across the array of thirty-two NADC units in grid rows “H” and “I”.

Considering the data throughput performance of each DSM and each NADC network interface to be “N”, this means that the data throughput performance of each RAID-set configuration varies widely. The data throughput performance of RAID-set 476 would be roughly 1N because all DSM data must pass through a single NADC network interface. The data throughput performance of RAID-set 478 would be roughly 16N. The data throughput performance of RAID-set 480 would be roughly 32N. This figure illustrates the power of distributing DSM elements widely across NADC units and network segments. The DSM units that comprise the three RAID-sets are shown representatively as 489. Those DSM units not a part of the RAID-sets of interest in this example are shown representatively as 488.

In this example two RPC units are shown as 472 and 482. The connectivity between RPC 472 and RAID-sets 476 and 478 is shown by the logical network connectivity 474. To fully and simultaneously utilize the network and data throughput available with RAID-sets 476 and 478 RPC 472 and logical network segment 474 would generally need an aggregate network data throughput capability of 17N. To fully utilize the network and data throughput available with RAID-set 480 RPC 482 and logical network segment 484 would need an aggregate network data throughput capability of 32N.

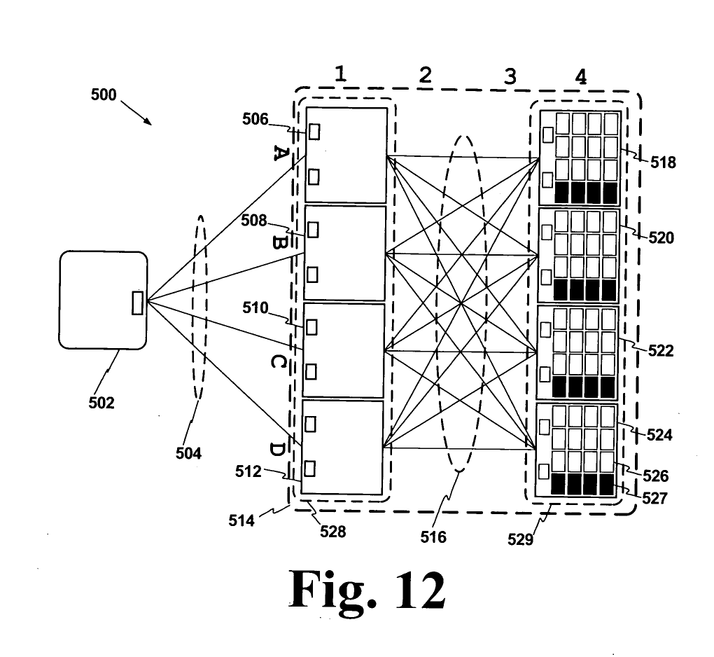

Referring to FIG. 12, a small distributed processing RAID system component configuration 500 subject to the present disclosure is shown. The block diagram shown represents a 4×4 array of NADC units 514 arranged to present an array of data storage and processing elements to a RAID-system network. The NADC units are used in both disk-management and RPC-processing roles. In this figure two columns (columns two and three) of NADC units within the 4×4 array of NADC units 514 have been removed to better highlight the network communication paths available between NADC units in columns one and four. This figure illustrates how an array of aggregated RPC functionality 528 provided by a number of NADC can be created and utilized to effectively manage a distributed RAID-set 529. Each NADC unit shown in column-four (518, 520, 522, and 524) presents four DSM units associated with the management of sixteen-DSM RAID-set elements 529.

To evaluate typical performance we start by considering the use of dual network attached NADC units as described previously. We consider that the data throughput performance of each DSM is capable of a data rate defined as “N”. Additionally, we define the data throughput performance of each NADC network interface to be “N” for simplicity. This then means that each NADC unit in column-four is capable of delivering RAID-set raw data at a rate of 2N. This then means that the raw aggregate RAID-set data throughput performance of the NADC array 529 is 8N. This 8N aggregate data throughput is then shown as 516. The DSM units that comprise the RAID-set shown are representatively shown as 527. Those DSM units not a part of the RAID-set of interest in this example are shown representatively as 526.

To illustrate the ability to aggregate RPC functionality using NADC units we presume that the data processing capabilities of a high-performance NADC can be put to work to perform this function. In this example the NADC units in column-one (506, 508, 510, and 512) will be used as an illustration. We start by defining the RPC processing power of an individual NADC unit to be “N” and the network data communication capabilities of each NADC to be 2N. The aggregate network bandwidth that is assumed to be available between a client computer system (CCS) 502 and the RAID system configuration 514 is then shown in aggregate as 504 and is equal to 8N. This aggregate RPC data throughput performance is available via the group of NADC units shown as 528 is then 4N. The overall aggregate data throughput rate available to the RAID-set 529 when communicating with CCS 502 via the LRPC 528 is then 4N. Although this is an improvement over a single RPC unit with data throughput capability “N”, more RPC data throughput capability is needed to fully exploit the capabilities of RAID-set 529.

Using a RAID-set write operation as an example we can have a CCS 502 direct RAID-write requests to the various NADC units in column-one 528 using a cyclical, well-defined, or otherwise definable sequence. Each NADC unit providing system-level RPC functionality can then be used to aggregate and logically extend the performance characteristics of the RAID system 514. This then has the effect of linearly improving system data throughput performance. Note that RAID-set read requests would behave similarly, but with predominant data flow in the opposite direction.

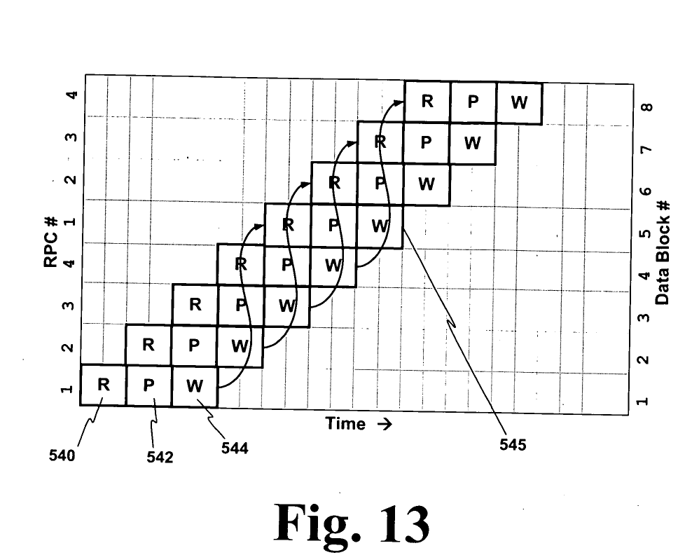

Referring to FIG. 13, a timing diagram for the small distributed processing RAID system component configuration 500 subject to the present disclosure is shown. The timing block diagram represents the small array of four NADC units 514 shown in FIG. 12 that is arranged to present an array of RPC processing elements to a RAID-system network. The diagram shows a sequence of eight RAID-set read or write operations (right-axis) being performed in a linear circular sequence by four distinct RPC logical units (left-axis). The bottom axis represents RPC transaction processing time.

In the example of a sequence of CCS 502 write operations to a RAID-set 529 is processed by a group of four NADC units 528 providing RPC functionality. This figure shows one possible RPC processing sequence and the processing speed advantages that such a method provides. If a single NADC unit was to be used for all RAID-set processing requests the speed of the RAID system in managing the RAID-set would be limited by the speed of the single RPC unit. By effectively distributing and effectively aggregating the processing power available on the network we can linearly improve the speed of the system. As described in FIGS. 12 and 13, system data throughput can be scaled to match the speed of the individual RAID-sets being managed.

To achieve such effective aggregation the example in this figure shows each logical network-attached RPC unit performing three basic steps. These steps are a network-read operation 540, a RPC processing operation 542, and a network-write operation 544. This sequence of steps appropriately describes RAID-set read or write operations, however, the direction of the data flow and the processing operations performed vary depending on whether a RAID-set read or write operation is being performed. The row of operations shown as 545 indicates the repetition point of the linear sequence of operations shown among the four RPC units defined for this example. Other well-defined or orderly processing methods could be used to provide effective and efficient RPC aggregation. A desirable characteristic of effective RPC aggregation is minimized network data bandwidth use across the system.

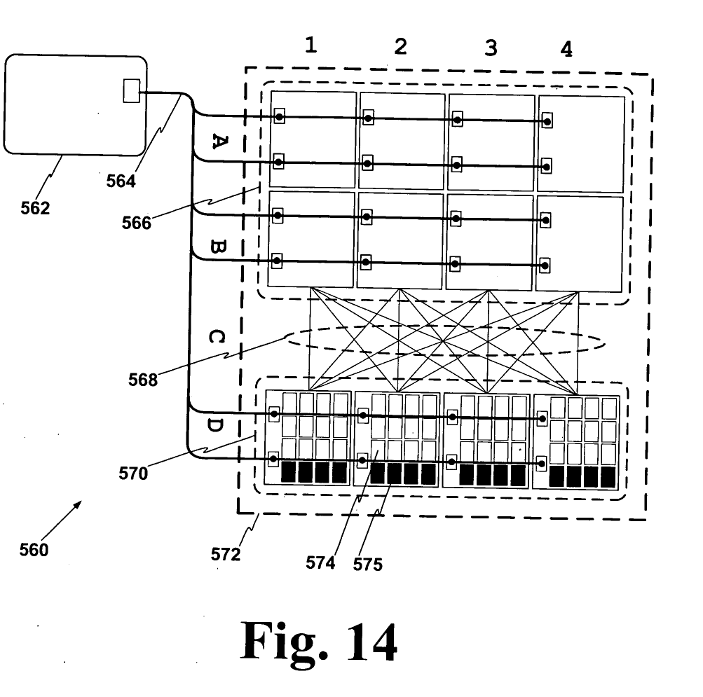

Referring to FIG. 14, a small distributed processing RAID system component configuration 560 subject to the present disclosure is shown. The block diagram shown represents a 4×4 array of NADC units 572 arranged to present an array of data storage and processing elements to a RAID-system network. This configuration is similar to that shown in FIG. 12. The NADC units are used in both disk-management and RPC-processing roles. In this figure one row (row “C”) of NADC units within the 4×4 array of NADC units 572 has been removed to better highlight the network communication paths available between NADC units in rows “A”, “B”, and “D”. This figure illustrates how an array of eight aggregated RPC functionality 566 provided by a number of NADC units can be created and utilized to effectively manage a distributed RAID-set 570. Each NADC unit shown in row-“D” presents four DSM units associated with the management of sixteen-DSM RAID-set elements 570.

This figure shows an array of four NADC units and sixteen DSM units providing RAID-set functionality to the network 570. The figure also shows how eight NADC units from the array can be aggregated to provide a distributed logical block of RPC functionality 566. In this example we again define the data throughput performance of each DSM is defined to be “N”, the network data throughput capacity of each NADC to be 2N, and the data throughput capabilities of each NADC providing RPC functionality to be N. The network connectivity between the NADC units in groups 570 and 566 is shown collectively as 568. The DSM units that comprise the RAID-set are shown representatively as 575. Those DSM units not a part of the RAID-sets of interest in this example are shown representatively as 574. The figure shows a CCS 562 communicating with logical RPC elements 566 within the array via a network segment shown as 564.

The effective raw network data throughput of RAID-set 570 is 8N. The effective RPC data throughput shown is also 8N. If the capability of the CCS 562 is at least 8N, then the effective data throughput of the RAID-set 570 presented by the RAID-system is 8N. This FIG. 560 shows the scalability of the method disclosed in effectively aggregating RPC functionality to meet the data throughput performance requirements of arbitrarily sized RAID-sets.

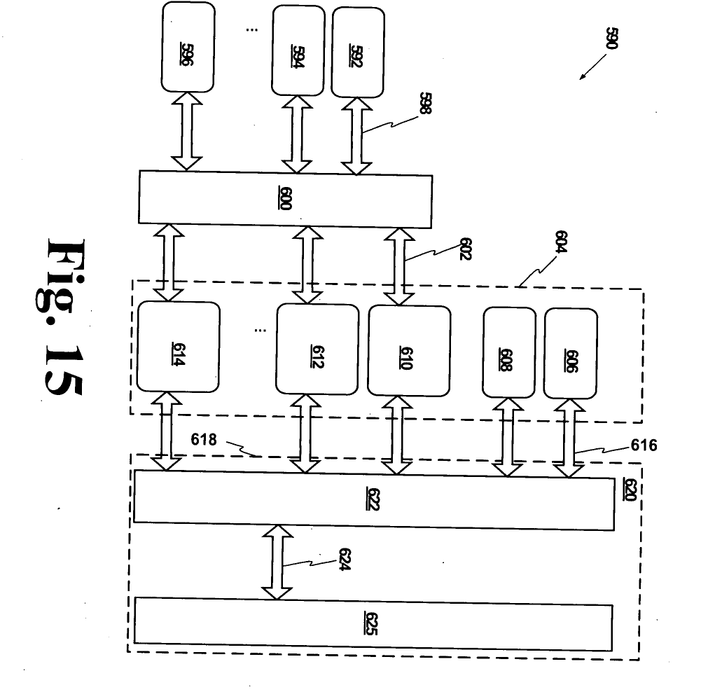

Referring to FIG. 15, a distributed processing RAID system component configuration 560 subject to the present disclosure is shown. The block diagram represents a distributed processing RAID system configuration 590 where the functionality of the RAID-system is connected to a variety of different types of external CCS machines. The distributed processing RAID system 620 connect through a series of external systems via a number of network segments representatively shown by 616. Various RAID-system components such as RPC units, NADC units, and other components are shown as 625. Internal RAID system Ethernet switching equipment and Ethernet data links are shown as 622 and 624 in a situation where the RAID-system is based on the use of an Ethernet communication network infrastructure. Two CCS systems (606 and 608) on the network communicate directly with the RAID-system 620 via Ethernet communication links shown representatively by 616.

As an example, to accommodate other types of CCS units (592, 594, through 596) that require Fibre-Channel (FC) connectivity when utilizing external RAID-systems the figure shows a FC-switch 600 and various FC data links shown representatively as 598 and 602. Such components are commonly a part of a Storage Area Network (SAN) equipment configuration. To bridge the communication gap between the FC-based SAN and the Ethernet data links of our example RAID-system an array of FC-Ethernet “gateway” units are shown by 610, 612, through 614. In this example, each FC-Ethernet gateway unit responds to requests from the various CCS units (592, 594, through 596), and translates the requests being processed to utilize existing RAID-system RPC resources. Alternately these gateway units can supplement existing system RPC resources and access NADC-DSM data storage resources directly using the RAID-system's native communication network (Ethernet in this example).

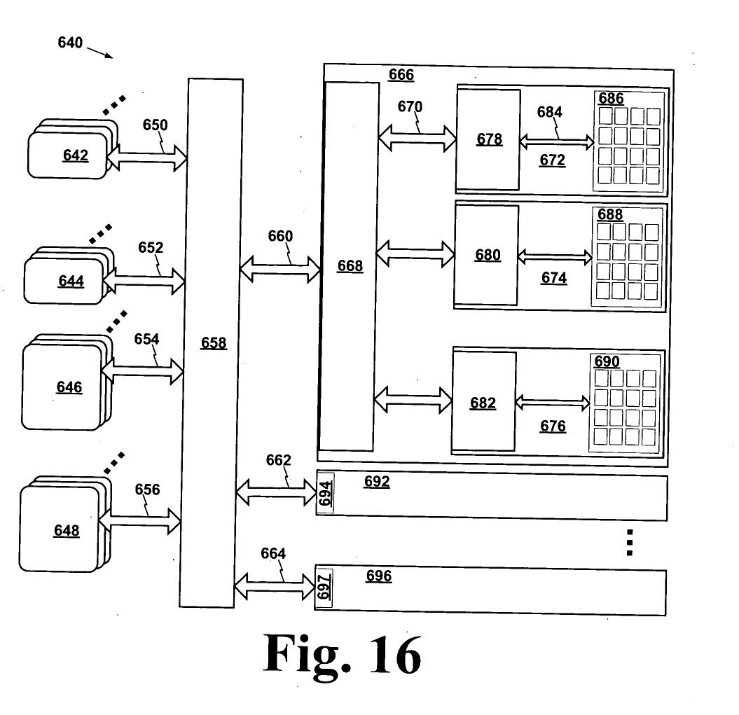

Referring to FIG. 16, a distributed processing RAID system component configuration 640 subject to the present disclosure is shown. The block diagram represents a distributed processing RAID system configuration 640 that generally exhibits relatively high performance due to the network component configuration shown. This example shows a RAID-system that is based on an Ethernet network communications infrastructure supported by a number of Ethernet switch units. Various Ethernet switch units are shown as 658, 668, 678, 680, 682, and at a high level by 694, and 697. The example configuration shown is characterized by the definition of three RAID-system “capability zones” shown as 666, 692, and 696.

Zone 666 is shown in additional detail. Within zone 666 three system sub-units (672, 674, and 676) are shown that generally equate to the capabilities of individual data storage equipment-racks or other equipment cluster organizations. Each sub-unit is shown to contain a small Ethernet switch (such as 678, 680, or 682). Considering sub-unit or equipment-rack 672, such a rack might be characterized by a relatively low-performance Ethernet-switch with sufficient communication ports to communicate with the number of NADC units within the rack.

As an example, if a rack 672 contains 16 dual network attached NADC units 686 as defined earlier an Ethernet-switch 678 with thirty-two communication ports would be minimally required for this purpose. However, to provide effective external network communication capabilities to equipment outside the equipment rack such a “zone” level Ethernet switch 668 such a switch 678 should provide at least one higher data rate communication link 670 so as to avoid introducing a network communication bottleneck with other system components. At the RAID-system level the higher performance data communication links from various equipment racks could be aggregated within a larger and higher performance zone-level Ethernet-switch such as that shown by 668. The zone-level Ethernet switch provides high-performance connectivity between the various RAID-system zone components and generally exemplifies a high-performance data storage system zone. Additional zones (692 and 696) can be attached to a higher-level Ethernet switch 658 to achieve larger and higher-performance system configurations.

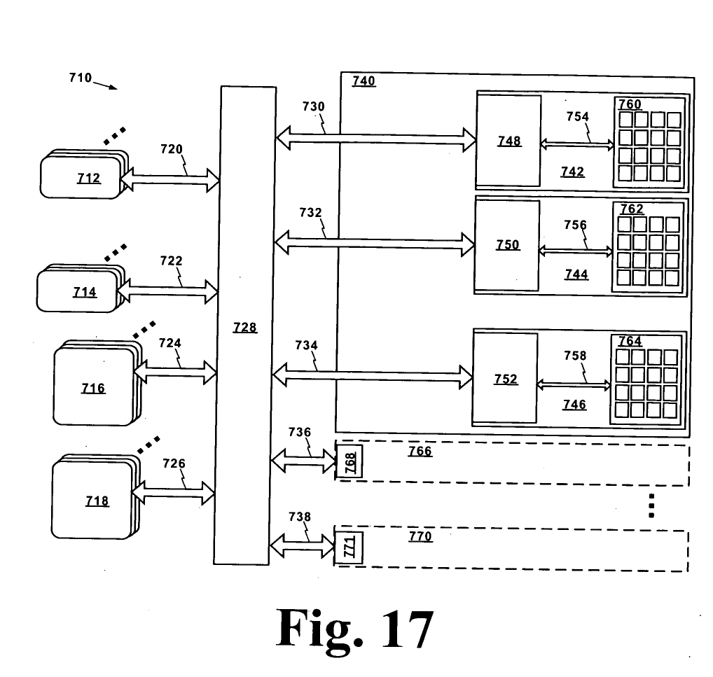

Referring to FIG. 17, a distributed processing RAID system component configuration 710 subject to the present disclosure is shown. The block diagram represents a distributed processing RAID system configuration that generally exhibits relatively low performance due to the network component configuration shown. The RAID-system is partitioned into three “zone” segments 740, 766, and 770. Each zone represents a collection of components that share some performance or usage characteristics. As an example, Zone-1 740 might be heavily used, Zone-2 766 might be used less frequently, and Zone-3 770 might be only rarely used. This example shows a RAID-system that is based on an Ethernet network communications infrastructure supported by a number of Ethernet switch units. Various Ethernet switch units are shown.

In this example a generally low-performance system configuration is shown that utilizes a single top-level Ethernet switch 728 for the entire distributed RAID-system. Ethernet switches 748, 750, and 752 are shown at the “rack” or equipment cluster level within zone 740 and these switches communicate directly with a single top-level Ethernet switch 728. Such a switched network topology may not provide for the highest intra-zone communication capabilities, but it eliminates a level of Ethernet switches and reduces system cost.

Other zones such as 766 and 770 may employ network infrastructures that are constructed similarly or provide more or less network communication performance. The general characteristic being exploited here is that system performance is largely limited only by the capabilities of the underlying network infrastructure. The basic building blocks constituted by NADC units (such as those shown in 760, 762, and 764), local communication links (754, 756, and 758), possible discrete zone-level RPC units, and other RAID system components remain largely the same for zone configurations of varying data throughput capabilities.

The figure also shows that such a RAID-system configuration can support a wide variety of simultaneous accesses by various types of external CCS units. Various FC-gateway units 712 are shown communicating with the system as described earlier. A number of additional discrete (and possibly high-performance) RPC units 714 are shown that can be added to such a system configuration. A number of CCS units 716 with low performance network interfaces are shown accessing the system. A number of CCS units 718 with high performance network interfaces are also shown accessing the system. Ethernet communication links of various capabilities are shown as 720, 722, 724, 726, 730, 732, 734, 736, and 738. The important features of this figure is that RAID-system performance can be greatly affected by the configuration of the underlying communication network infrastructure and that such a system can be constructed using multiple zones with varying performance capabilities.

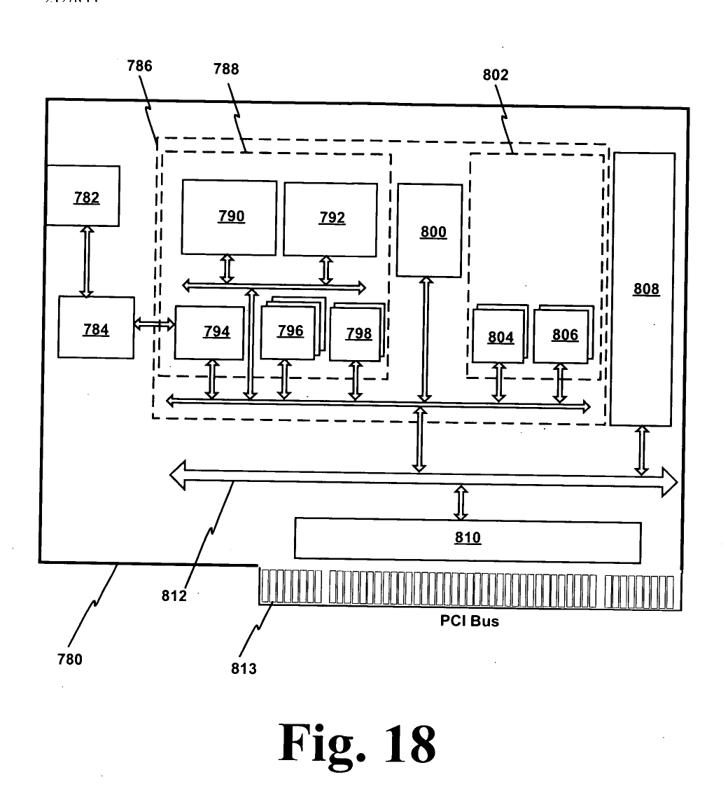

Referring to FIG. 18, a PCI accelerator card envisioned for typical use within a distributed processing RAID system component configuration 780 subject to the present disclosure is shown. The block diagram shown represents an example network interface PCI card 780 that can be used to minimize the performance degradation encountered by typical CCS units when performing high data rate transactions over network interfaces utilizing high-level communication protocols such as the TCP/IP protocol over Ethernet. This figure shows a PCI bus connector 813 connected to an internal processing bus 812 via a block of PCI bus interface logic 810. The internal processing engine 786 provides a high-level interface to the CCS host processor thereby minimizing or eliminating the overhead typically associated with utilizing high-level communication protocols such as TCP/IP over Ethernet. The Ethernet interface is represented by physical, interface, and control logic represented by blocks 782, 784, and 794 respectively.

Two internal processing engines are shown. A host interface engine is shown by 802. An IP-protocol processing engine is shown by 788. These local engines are supported by local memory shown as 808 and timing and control circuitry shown as 800. The host processing engine consists of one or more local processing units 806 optionally supported by DMA 804. This engine provides an efficient host interface that requires little processing overhead when used by a CCS host processor. The IP protocol processing engine consists of one or more local processing units 796 supported by DMA 798 along with optional packet assembly and disassembly logic 792 and optional separate IP-CRC acceleration logic 790. The net result of the availability of such a device is that it enables the use of high data rate network communication interfaces that employ high-level protocols such as TCP/IP without the CPU burden normally imposed by such communication mechanisms.

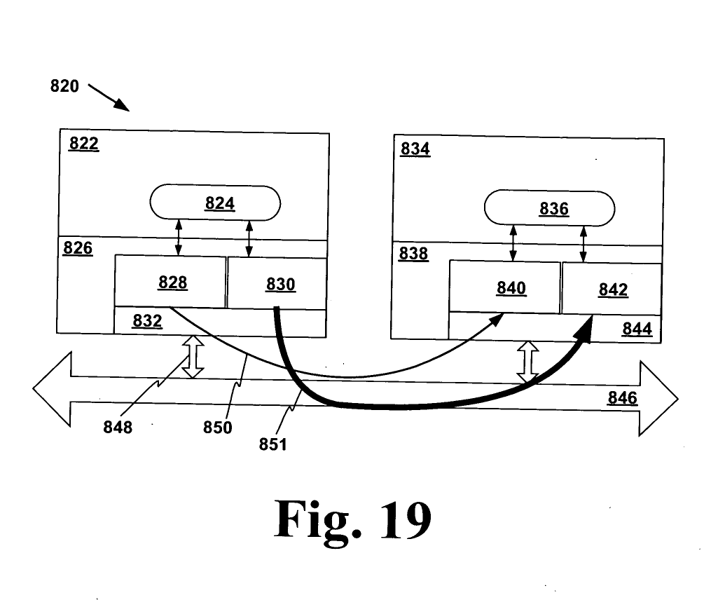

Referring to FIG. 19, a software watt diagram for an envisioned efficient software communications architecture for typical use within a distributed processing RAID system component configuration 820 subject to the present disclosure is shown. The block diagram shown represents two high-speed communication elements 822 and 834 communicating over a fast communications network such as gigabit Ethernet in an environment where a high-level protocol such as TCP/IP is typically used for such communication. The underlying Ethernet network communication infrastructure is 846. Individual Ethernet communication links to both nodes is 848. The use of high-level protocols such as TCP/IP when performing high data rate transactions is normally problematic because it introduces a significant processing burden on the processing elements 822 and 834. Methods to minimize this processing burden would generally be of great value to large network-centric RAID systems and elsewhere.

The figure shows typical operating system environments on both nodes where “user” and “kernel” space software modules are shown as 822-826 and 834-838, respectively. A raw, low-level, or driver level, or similar Ethernet interface is shown on both nodes as 832 and 844. A typical operating system level Internet protocol processing module is shown on both nodes as 828 and 840, respectively. An efficient low-overhead protocol-processing module specifically tailored to effectively exploit the characteristics of the underlying communication network being used (Ethernet in this case) for the purpose of implementing reliable and low-overhead medication is shown on both nodes as 830 and 842 respectively. As shown, the application programs (824 and 836) can communicate with one another across the network using standard TCP/IP protocols via the communication path 824-828-832-846-844-840-836, however, high data rate transactions utilizing such IP-protocol modules generally introduces a significant burden on both nodes 822 and 834 due to the management of the high-level protocol.

Typical error-rates for well-designed local communication networking technologies are generally very low and the errors that do occur can usually be readily detected by common network interface hardware. As an example, low-level Ethernet transactions employ a 48-bit AAL5 CRC on packets transmitted. Therefore, various types of well-designed low-overhead protocols can be designed that avoid significant processing burdens and exploit the fundamental characteristics of the network communication infrastructure and the network hardware to detect errors and provide reliable channels of communication. Using such methods application programs such as 824 and 836 can communicate with one another using low overhead and reliable communication protocols via the communication path 824-830-832-846-844-842-836. Such low-level protocols can utilize point-two-point, broadcast, and other communication methods.

The arrow 850 shown represents the effective use of TCP/IP communication paths for low data rate transactions and the arrow 851 represents the effective use of efficient low-overhead network protocols as described above for high data rate transactions.

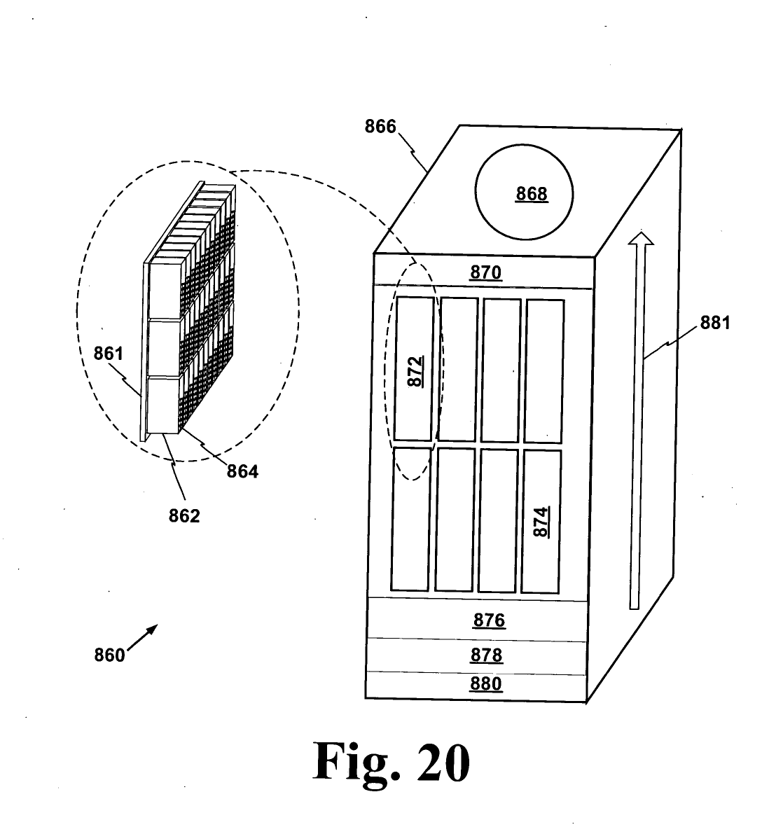

Referring to FIG. 20, an equipment rack configuration such as might be found within a distributed processing RAID system component configuration 860 subject to the present disclosure is shown. The block diagram shown represents a physical data storage equipment rack configuration 860 suitable for enclosing large numbers of DSM units, NADC units, power supplies, environmental monitors, networking equipment, cooling equipment, and other components with a very high volumetric efficiency. The enclosing equipment rack is 866. Cooling support equipment in the form of fans, dynamically adjustable air baffles, and other components is shown to reside in areas 868, 870 and 876 in this example. Items such as power supplies, environmental monitors, and networking equipment are shown to reside in the area of 878 and 880 in this example.

Typical industry-standard racked-based equipment packaging methods generally involve equipment trays installed horizontally within equipment racks. To maximize the packaging density of NADC units and DSM modules the configuration shown utilizes a vertical-tray packaging scheme for certain high-volume components. A group of eight such trays are shown representatively by 872 through 874 in this example. A detailed view of a single vertical tray is shown 872 to the left. In this detail view NADC units could potentially be attached to the left side of the tray shown 861. The right side of the tray provides for the attachment of a large number of DSM units 862, possibly within individual enclosing DSM carriers or canisters. Each DSM unit carrier/canister is envisioned to provide sufficient diagnostic indication capabilities in the form of LEDs or other devices 864 such that it can potentially indicate to maintenance personnel the status of each unit. The packaging configuration shown provides for the efficient movement of cooling airflow from the bottom of the rack toward the top as shown by 881. Internally, controllable airflow baffles our envisioned in the area of 876 and 870 so that cooling airflow from the enclosing facility can be efficiently rationed.

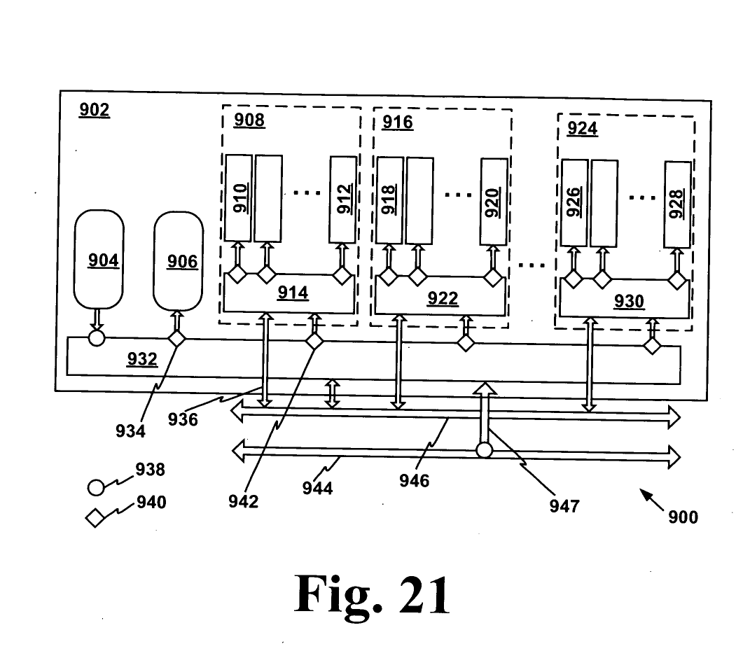

Referring to FIG. 21, a block diagram 900 representing internal control operations for a typical data storage rack within a distributed processing RAID system configuration subject to the present disclosure is shown. The diagram shows a typical high-density data storage equipment rack 902 such as that shown in FIG. 20. Because of the large number of components expected to reside within each equipment rack within a large distributed processing RAID-system configuration, extraordinary measures must be taken to conserve precious system and facility resources. NADC-DSM “blocks” are shown as 908, 916, and 924. DSM units are shown as 910 through 912, 918 through 920, and 926 through 928. Individual NADC units are shown as 914, 922, and 930. Internal rack sensors and control devices are shown as 904. Multiple internal air-movement devices such as fans are shown representatively as 906. A rack Local Environmental Monitor (LEM) that allows various rack components to be controlled from the network is shown as 932.

The LEM provides a local control system to acquire data from local sensors 904, adjust the flow of air through the rack via fans and adjustable baffles 906, and it provides the capability to control power to the various NADC units (914, 922, and 930) within the rack. Fixed power connections are shown as 938. Controllable or adjustable power or servo connections are shown as 940, 934, and representatively by 942. External facility power that supplies the equipment rack is shown as 944 and the power connection to the rack is shown by 947. The external facility network is shown by 946 and the network segment or segments connecting to the rack is shown representatively as 936.

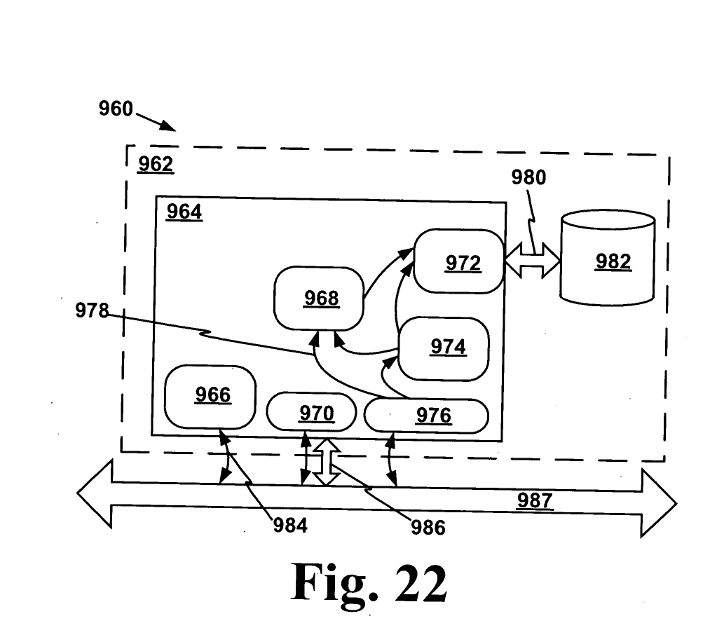

Referring to FIG. 22, a block diagram 960 representing an internal software subsystem for possible use within a typical distributed processing RAID system configuration subject to the present disclosure is shown. The diagram shows certain envisioned software modules of a typical RAID-Control-System (RCS) 962. The external network infrastructure 987 provides connectivity to other RAID-system components. Within the RCS the allocation of system resources is tracked through the use of a database management system whose components are shown schematically as 972, 980, and 982. A Resource Management module 968 is responsible for the allocation of system network resources. Network interfaces for the allocation and search components shown are exposed via module 976. An internal search engine 974 supports resource search operations. A RAID System Health Management module 966 provides services to support effective RAID-system health monitoring, health management, and error recovery methods. Other associated RAID-system administrative services are exposed to the network via 970. Paths of inter-module communication are shown representatively by 978. Physical and logical connectivity to the network is shown by 986 and 984 respectively. The overall purpose of the components shown is to support the effective creation, use, and maintenance of RAID-sets within the overall network-centric RAID data storage system.

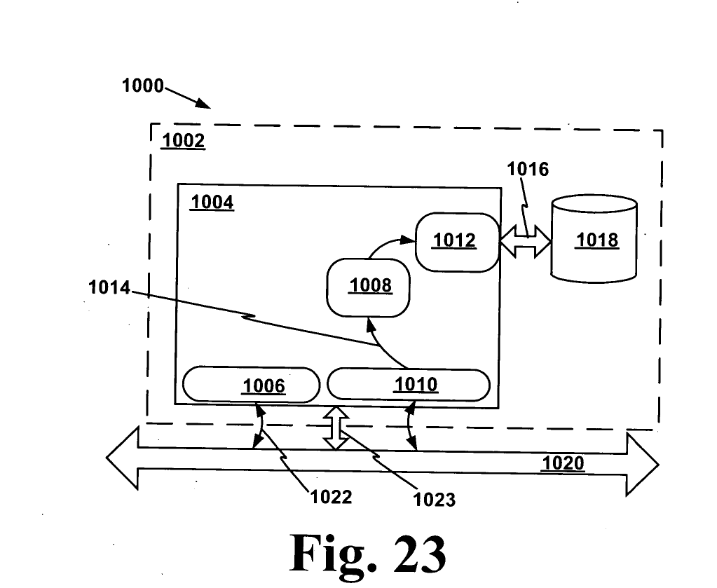

Referring to FIG. 23, a block diagram 1000 representing an internal software subsystem for possible use within a typical distributed processing RAID system configuration subject to the present disclosure is shown. The diagram shows certain envisioned software modules of a typical Meta-Data Management System (MDMS)) 1004. The envisioned purpose of the MDMS shown is to track attributes associated with large stored binary objects and to enable searching for those objects based on their meta-data attributes. The boundary of the MDMS is shown by 1002. A system that runs the MDMS software components is shown as 1004. The external network infrastructure is shown by 1020. Within the MDMS attributes are stored and managed through the use of a database management system whose components are shown schematically as 1012, 1016, and 1018. An attribute search-engine module is shown as 1008. Network interfaces for the enclosed search capabilities are shown by 1010 and 1006. Paths of inter-module communication are shown representatively by 1014. Physical and logical connectivity to the network is shown by 1023 and 1022. The overall purpose of the components shown is to support the effective creation, use, and maintenance of meta-data associated with binary data objects stored within the larger data storage system.

The use of Extended RAID-set error recovery methods is required in many instances.

The use of a time-division multiplexing of RAID management operations.

The use of DISTRIBUTED-mesh RPC dynamic component allocation methods. A system that is comprises a dynamically-allocatable or flexibly-allocatable array of network-attached computing-elements and storage-elements organized for the purpose on implementing RAID storage.

The use of high-level communication protocol bypassing for high data rate sessions. My friend at HP said Broadcom just came out with a TCP/IP accelerator chip (12 JAN. 2006).

The use of effective power/MTBF-efficient component utilization strategies for large collections of devices.

The use of proactive component health monitoring and repair methods to maintain high data availability.

The use of effective redundancy in components to improve data integrity & data availability.

The use of dynamic spare drives and controllers RAID-set provisioning and error recovery operations.

The use of effective methods for large RAID-set replication using time-stamps to regulate the data replication process.

The use of data storage equipment zones of varying capability based on data usage requirements.

The use of vertical data storage-rack module packaging schemes to maximize volumetric packaging density.

The use of disk-drive MTBF tracking counters both within disk-drives and within the larger data storage system to effectively track MTBF usage as components are used in a variable fashion in support of effective prognostication methods.

The use of methods to store RAID-set organizational information on individual disk-drives to support a reliable and predictable means of restoring RAID-system volume definition information in the event of the catastrophic failure of centralized RAID-set definition databases.

The use of rapid disk drive cloning methods to replicate disk drives suspected of near-term future failure predicted by prognostication algorithms.

The use of massively parallel RPC aggregation methods to achieve high data throughput rates.

The use of RAID-set reactivation for health checking purposes at intervals recommended by disk drive manufacturers.

The use of preemptive repair operations based on peripherally observed system component characteristics.

The use of vibration sensors, power sensors, and temperature sensors to predict disk drive health.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A distributed processing RAID system comprising:
a plurality of network attached disk controllers that include at least one network connection,
a plurality of data storage units, each data storage unit including a local data processor; and
a plurality of RAID processing and control units, each RAID processing and control unit including at least one network connection and a local data processor.
